(19) United States
(12) Patent Application Publication
(10) Pub. No.: US 2025/0372922 A1
(43) Pub. Date: Dec. 4, 2025

(54) BUS BAR MODULE CONNECTOR FOR ELECTRONIC SYSTEM

(71) Applicant: FCI USA LLC, Etters, PA (US)

(72) Inventors: Ronald Nico Adriaan Daamen, Vught (NL); Thierry Goossens, Herdersem (BE)

(73) Assignee: FCI USA LLC, Etters, PA (US)

(21) Appl. No.: 19/223,675

(22) Filed: May 30, 2025

Related U.S. Application Data
(60) Provisional application No. 63/653,696, filed on May 30, 2024.

(51) Int. Cl. H01R 13/631; H01R 9/24; H01R 9/26; H01R 12/70; H01R 12/72

(52) U.S. Cl. CPC H01R 13/6315; H01R 9/2408; H01R 9/2675; H01R 12/7088; H01R 12/722

(57) ABSTRACT

A bus bar module to connect to like bus bar modules for power delivery within an electronic system. The modules may include connectors that enable mating between the bus bars despite misalignment between the bus bar modules in one or more directions. The bus bar module may include an extendable interface, which may be extended to engage an adjacent bus bar module or retracted to allow a bus bar module to be inserted or removed from between two other bus bare modules. That extendable interface may include a component that can pivot to accommodate for misalignment in one direction and with contact surfaces shaped relative to mating contact surfaces that accommodate for misalignment in one or more orthogonal directions.

### CROSS-REFERENCE TO RELATED APPLICATIONS

This application claims priority to and the benefit under 35 U.S.C. § 119(e) of U.S. Provisional Patent Application No. 63/653,696, filed on May 30, 2024, entitled “BUS BAR MODULE CONNECTOR FOR ELECTRONIC SYSTEM.” The contents of this application are incorporated herein by reference in their entirety.

### FIELD

This patent application relates generally to electronic systems and more particularly to power distribution within electronic systems.

### BACKGROUND

An electronic system may contain multiple assemblies, which are interconnected so that they operate as a system. A high performance computer, for example, may have assemblies implemented by attaching electronic components to printed circuit boards (PCBs). One PCB may have a processor. Others may hold co-processors, memory, power supplies or other specialized circuits.

Interconnections between these PCBs may be made with connectors. Such an architecture can provide advantages for both manufacturers and users of those systems. PCBs can be easily connected in the system at the time of manufacture or after the system is put into use. A user, for example, may connect a PCB with more memory into the system to increase the performance of the computer.

Different types of connectors may be used for different functions. Signal connectors that move data between PCBs in the system may be configured for high frequency operation. Connectors that distribute power may have a different configuration that carries large currents.

For distribution of power, bus bars may pass through the system. PCBs may have connectors that connect to the appropriate bus bars to draw power at a voltage required for operation of the components on the PCB. In some systems, a bus bar may be a unitary component. In other systems, a bus bar may be assembled from segments that are themselves interconnected with connectors. A system may have multiple bus bar modules, each of which contains a segment of one or more bus bars. To form an electronic system, multiple bus bar modules may be chained together to form a bus bar of a desired length. Printed circuit boards throughout the system may then be connected to bus bar segments.

### BRIEF SUMMARY

Some embodiments are directed to an electrical connector configured for mating with at least one mating component, the connector comprising: a first housing having a mating face; a first conductive element held within the first housing; a second housing movably coupled to the first housing such that the second housing is movable between at least a first position with respect to the first housing and a second position with respect to the first housing; and a second conductive element movably mounted in the second housing and positioned to be guarded by the first housing when the second housing is in the first position and to engage with the first conductive element and be exposed for mating with the at least one mating component at the mating face when the second housing is in the second position.

Some embodiments are directed to a connection module for an electronic assembly configured to engage with a like connection module and a printed circuit board, the connection module comprising: a first conductive element comprising: a first portion extending along a first axis from a first end to a second end, the first portion comprising a first mating contact area at the first end and a second mating contact area at the second end; and a second portion extending from the first portion transversely to the first axis and having an end opposite the first portion, the end of the second portion comprising a third mating contact area configured to engage a printed circuit board; and a second conductive element movably mounted in the connection module such that the second conductive element is movable into an extended position, wherein the second conductive element is configured to engage the first mating contact area when the second conductive element is in the extended position and to engage a second like connection module at the second mating contact area of the first conductive element of the second like connection module when the second conductive element is in the extended position.

Some embodiments are directed to a connection module for an electronic assembly configured to engage with a like connection module and a printed circuit board, the connection module comprising: a first conductive element comprising: a first portion extending along a first axis from a first end to a second end, the first portion comprising a first mating contact area at the first end and a second mating contact area at the second end; and a second portion extending from the first portion transversely to the first axis and having an end opposite the first portion, the end of the second portion comprising a third mating contact area configured to engage a printed circuit board; a second conductive element comprising a first end configured to engage the first mating contact area and a second end comprising a mating contact area, wherein: the second conductive element is pivotally mounted in the connection module such that the mating contact area at the second end of the second conductive element moves in a direction perpendicular to the first axis when the second conductive element pivots.

Some embodiments are directed to an electronic assembly comprising a plurality of connection modules configured for separable connection between the connection modules, wherein: a first connection module of the plurality of connection modules comprises a first mating interface comprising a first conductive element; a second connection module of the plurality of connection modules comprises a second mating interface comprising a second conductive element, wherein the second connection module is configured for connection to the first connection module at the first mating interface; the electronic assembly comprises a member comprising a third conductive element; and the member is movably mounted to move between a first position in which the third conductive element engages one of the first conductive element or the second conductive element and a second position in which the third conductive element engages both the first conductive element and the second conductive element.

Some embodiments are directed to a method of operating an electronic system including a plurality of connection modules comprising: positioning a first connection module adjacent to a second connection module, wherein the first connection module is offset from the second connection module along a first axis; and moving a mating contact portion of a third conductive element from the first connection module into engagement with a second conductive element in the second connection module, wherein during the moving the mating contact portion is driven in the direction of the first axis and compliant in a direction perpendicular to the first axis.

These techniques may be used alone or in any suitable combination. The foregoing summary is provided by way of illustration and is not intended to be limiting.

### BRIEF DESCRIPTION OF DRAWINGS

The accompanying drawings may not be drawn to scale. In the drawings, each identical or nearly identical component that is illustrated in various figures may be represented by a like numeral. For purposes of clarity, not every component may be labeled in every drawing. In the drawings:

FIG. 1 is a perspective view of an exemplary bus bar module with a printed circuit board connected to receive power, in accordance with some embodiments of the technology described herein.

FIG. 2A is a perspective view of multiple interconnected exemplary bus bar modules, with printed circuit boards drawing power form the bus bar modules hidden, in accordance with some embodiments of the technology described herein.

FIG. 2B is a side view of a first bus bar module connected to a second bus bar module, with the housings of the first and second bus bar modules hidden to reveal conductive structures within the bus bar modules.

FIG. 3A is a perspective view of three interconnected bus bar modules, in accordance with some embodiments of the technology described herein.

FIG. 3B is a perspective view of the three bus bar modules in a state in which the bus bar modules are not interconnected to schematically illustrate that a first bus bar module can be inserted or removed from between a second and a third bus bar modules, in accordance with some embodiments of the technology described herein.

FIG. 4A is a perspective view of a bus bar module with a sliding portion in a retracted position, in accordance with some embodiments of the technology described herein.

FIG. 4B is a perspective view of the bus bar module of FIG. 4A with the sliding portion in an extended position, in accordance with some embodiments of the technology described herein.

FIG. 5A is an exploded view of the bus bar module of FIG. 4A, in accordance with some embodiments of the technology described herein.

FIG. 5B is an exploded view of an alternative embodiment of a bus bar module, in accordance with some embodiments of the technology described herein.

FIG. 6A is a cross section of a portion of a first bus bar module adjacent a portion of a second bus bar module, with a sliding portion of the first bus bar module in a retracted position, in accordance with some embodiments of the technology described herein.

FIG. 6B is a cross section of the portions of the first bus bar module and the second bus bar module of FIG. 6A, with the sliding portion of the first bus bar module in an extended position, in accordance with some embodiments of the technology described herein.

FIG. 7A is a cross section of the portions of the first bus bar module and the second bus bar module of FIG. 6B, with the sliding portion of the first bus bar module in an extended position and an offset between the first and second bus bar modules perpendicular to the sliding axis, in accordance with some embodiments of the technology described herein.

FIG. 7B is a cross section of the portions of the first bus bar module and the second bus bar module of FIG. 6B, with the sliding portion of the first bus bar module in an extended position and an offset between the first and second bus bar modules perpendicular to the sliding axis and in a direction opposite to that shown in FIG. 7A, in accordance with some embodiments of the technology described herein.

FIG. 8 is a perspective view of a portion of an extendable assembly of FIG. 5A with portions cutaway to reveal a conductive element pivotably mounted in the extendable assembly, in accordance with some embodiments of the technology described herein.

FIG. 9 is a perspective view of a portion of the extendable assembly of FIG. 5A, in accordance with some embodiments of the technology described herein.

FIG. 10 is a top view of portions of two mated bus bar modules, with portions of the housings of the bus bar modules partially cut away to reveal electrical coupling between the bus bar modules through a conductive blade, in accordance with some embodiments of the technology described herein.

### DETAILED DESCRIPTION

The inventors have recognized and appreciated that electronic systems may be more easily manufactured or reconfigured with connectors in bus bar modules that compensate for misalignment of the bus bar modules in one or more directions. Connectors with this capability enable reliable delivery of power to the assemblies of the electronic system even if the busbar modules are out of alignment when assembled or as a result of movement of the busbar modules during use. The inventors have further recognized and appreciated designs for such connectors. Connector design techniques may compensate for misalignment, for example, in one, two or three orthogonal directions.

These design techniques may be implemented with a first type connector that mates with a second type connector. The first type connector may be part of a mating interface of a first bus bar module. The second type connector may be part of a mating interface of a second bus bar module. The second bus bar module may be positioned next to the first bus bar module and connected at their mating interfaces. In some systems, each bus bar module may have at least two mating interfaces, one of which may have a first type connector on one side of the bus bar module and the other of which may have a second type connector on another side of the bus bar module. Like bus bar modules may be aligned side to side, with a first type connector of one module positioned to mate with a second type connector of another, like bus bar module, to interconnect the bus bar modules into one or more bus bars. Such a configuration may be formed with a conductive element that has mating contact surfaces at two ends, one forming a portion of a first type connector and the other forming a portion of a second type connector. The conductive element may have an intermediate portion from which a third mating contact extends for mating with a PCB.

The first type connector may include at least two conductive elements, one of which is movable with respect to the other for connecting adjacent bus bar modules, even if the bus bar modules are out of alignment. In some examples, the first type connector may have a first housing and a second housing that is movably mounted relative to the first housing. A first conductive element, which may form a portion of a terminal of a first type connector, may be mounted within the first housing.

A second conductive element, which may form another portion of the terminal of the first type connector, may be mounted in the second housing. When the second housing is in a first position, the second conductive element may be guarded by the first housing. When the second housing is moved into an extended position, the second conductive element may extend from the first housing where it can pass through the mating interface of a second type connector of a second bus bar module, connecting the first and second connectors.

Moving the second conductive element along a first axis enables the bus bar modules to be moved into position for connection without interference with the conductive elements that span bus bar modules. A second module, for example, may be slid into a space between a first bus bar module and a third bus bar module, even if the second bus bar module has surfaces flush with the surfaces of the first and third bus bar modules. These three bus bar modules may nonetheless be connected by moving the second conductive element of the first type connector in at least the first and second bus bar modules into engagement with a conductive element of a second type connector in the adjacent bus bar modules.

The second conductive element of the first type connector may be configured, such as via its shape and/or mounting arrangement, to enable connections even if there is misalignment between the bus bar modules in at least one direction. The second conductive element, for example, may move along a first axis to engage a second type connector. Such operation may be achieved by a mounting of the second conductive element in the second housing such that the second conductive element is driven by engagement with the second housing when the second housing is moved along the first axis. The second conductive element may have a mating contact surface that is elongated so as to make contact with the mating contact surfaces of the conductive element of the second type connector over a range of relative positions of the second conductive element and the conductive element of the second type connector, allowing two bus bar modules to be connected despite more than a nominal separation along the first axis.

Alternatively or additionally, the second conductive element may be configured to compensate for misalignment in one or more directions transverse to the first axis. In some examples, the second conductive element may be movably mounted in the second housing. The second conductive element may be pivotably mounted about a second axis, perpendicular to the first axis. In such an example, pivoting of the second conductive element about the second axis imparts a range of motion to the mating contact surface that is at least 0.7 mm, along a third axis, which in this example is mutually perpendicular to the first and second axes.

Alternatively or additionally, the mating contact surfaces of the second conductive element and the conductive element in a second type connector may be of different widths in a direction of the second axis. The mating contact surface of the second conductive element, for example, may be wider than the mating contact area of the mating conductive element of the second type connector. The difference in width enables a range of relative positions of the first type connector and the second type connector, such as 0.7 mm. That range of mating positions accommodates for misalignment of the same range between a first bus bar module with the first type connector and a second bus bar module with the second type connector in the same range.

One or more of these techniques may be used in a bus bar module. In examples in which translation along an axis, pivoting and differences in width of the mating contact portions are simultaneously employed, misalignment in three dimensions may be accommodated.

Bus bar modules as described herein may be interconnected into a bus bar for power delivery in an electronic system. The bus bar modules may include power connectors positioned such that assemblies forming the electronic system may be connected to the bus bar. Misalignments between assemblies or misalignments between the bus bar modules may cause the power connectors of the bus bar modules to be misaligned. Bus bar modules with connectors as described herein may, nonetheless operate to deliver power to the assemblies.

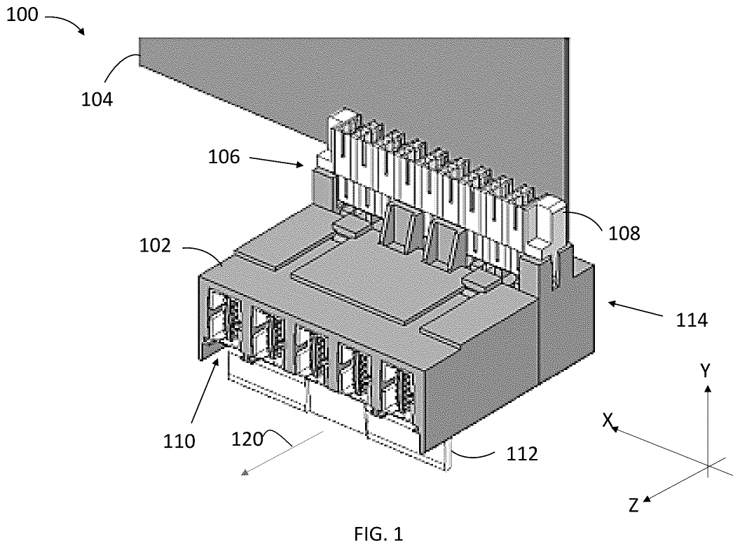

Turning to the figures, an example of a bus bar module that accommodates for misalignment of bus bar modules is provided. In the example illustrated, the exemplary bus bar modules accommodate for misalignment in three orthogonal directions. FIG. 1 is a perspective view an exemplary bus bar module 100 with a printed circuit board connected to receive power, in accordance with some embodiments of the technology described herein. The illustrated portion of the power delivery system 100 includes a bus bar module 102 configured to power a PCB 104 mated to the bus bar module 102. For establishing electrical connectivity between bus bar module 102 and PCB 104, bus bar module 102 includes PCB mating interface 106, which in this example is configured for receiving a PCB connector 108.

The electrical connectivity between the bus bar module 102 and PCB 104 may be configured in any suitable way. In some embodiments bus bar module 102 includes conductive elements with mating contact portions positioned for making separable connections with PCB connector 108. The mating contact portions may be, for example, blades, spring fingers or pins. In other examples, the mating contact portions of bus bar module 102 may directly connect to the PCB without an intermediate connector 108. Such mating contact portions, for example, may have beams configured for making a connection with electrical pads on the PCB. In some embodiments, any other suitable mating connection between PCB 104 and bus bar module 102 may be used, as aspects of the technology described herein are not limited in this respect.

Bus bar module 102 may have an extendable interface 110 and a receiving interface 114. Extendable interface 110 and receiving interface 114 may have complementary configurations that mate with each other. Such a configuration enables a first bus bar module to mate with a second, like bus bar module when the extendable interface 110 of the first bus bar module is positioned next to the receiving interface 114 of the second bus bar module.

Each interface may include mating contact portions of multiple conductive elements that may be interconnected when adjacent bus bar modules are mated. In the example of FIG. 1, there are five conductive elements. These conductive elements may be electrically isolated from each other within the bus bar module 102 such that each may serve as a bus bar and may be a separate leg of a power circuit. In other examples, two or more of the conductive elements may be connected within the bus bar module 102 to carrying large currents. The conductive elements may also be connected to mating contact portions at mating interface 106 such that each level of power may also be delivered to a connected PCB, such as PCB 104.

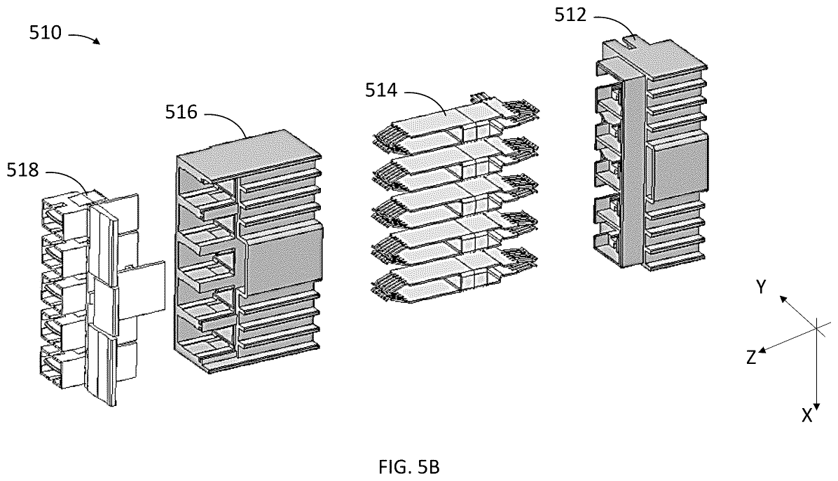

In the example of FIG. 1, extendable interface 110 and receiving interface 114 are on opposite sides of the bus bar module 102, separated along an axis of extension 120. In the example illustrated, the extendable interface may be formed with an extendable terminal assembly (e.g. extendable terminal assembly 506, FIG. 5A) including one or more conductive elements including mating contact portions that may be extended along the axis of extension 120. When extended, the mating contact portions of the conductive elements of the extendable terminal assembly may be exposed for entering into an interface configured like receiving interface 114.

Bus bar module may include a suitable mechanism for adjusting the position of the extendable terminal assembly. The extendable terminal assembly may be integrated into a housing of the bus bar module such that it is movable between an extended positions and a retracted position. In an extended position, the extendable terminal assembly extends beyond the module housing and may mate with the corresponding mating terminals on an adjacent bus bar module. In a retracted position, the extendable terminal assembly is retracted within the module housing and is not mated with an adjacent bus bar module. In some embodiments, bus bar module 102 may include tab 112 that a user may grasp for moving the extendable terminal assembly between the extended and retracted positions. In the example of FIG. 1, tab 112 may be pushed along the axis of extension 120 to slide the extendable terminal assembly into the extended position. Similarly, the tab may be pushed backward to slide the extendable terminal assembly into the retracted position.

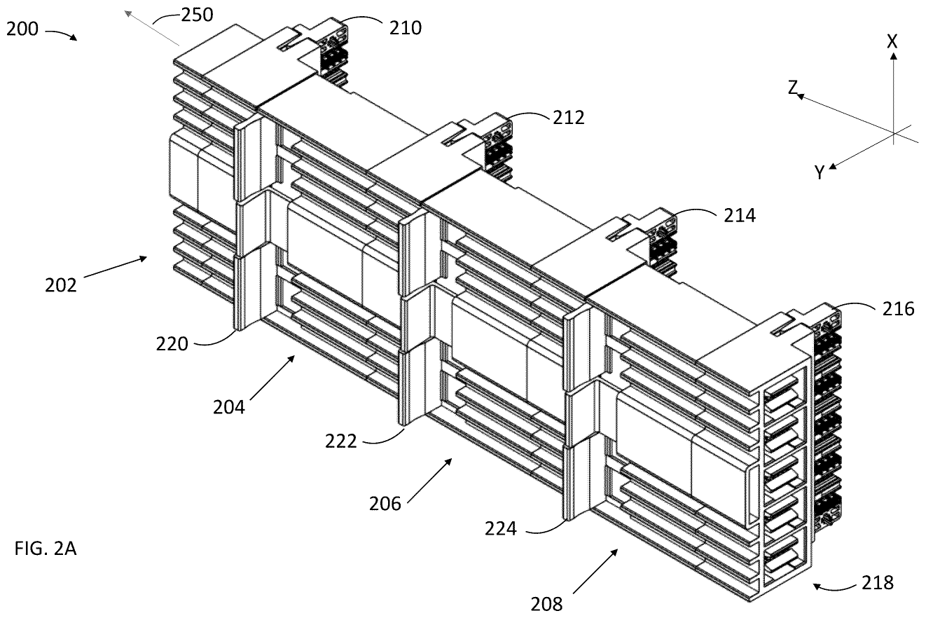

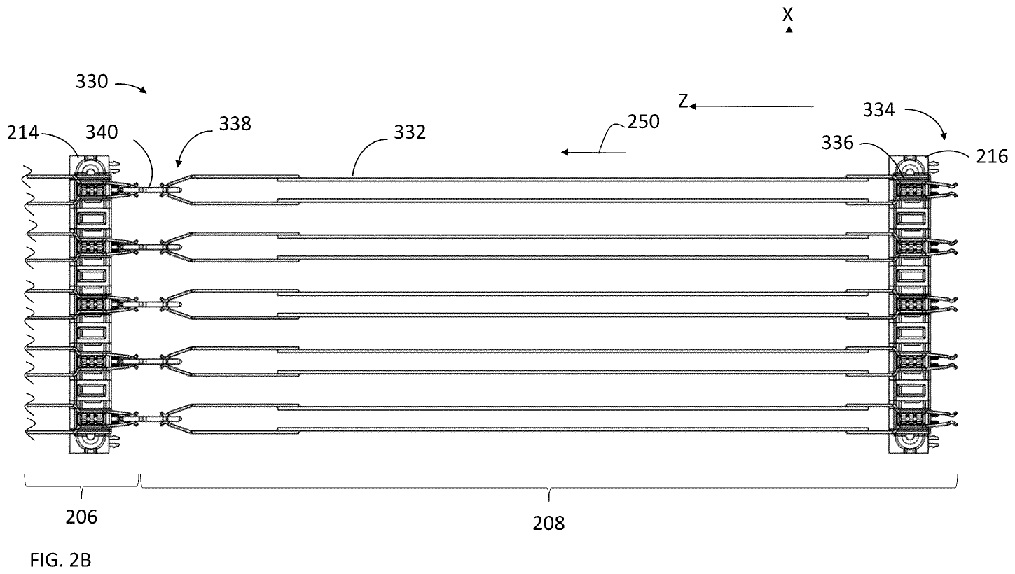

FIG. 2A is a perspective view of a portion of a power delivery subsystem 200, in accordance with some embodiments of the technology described herein. FIG. 2A shows multiple interconnected exemplary bus bar modules, with printed circuit boards drawing power form the bus bar modules hidden. Power delivery subsystem 200 includes multiple bus bar modules mated together, e.g., in a daisy chain configuration. In this example, each of the bus bar modules has a mating interface, which may be as described above for mating interface 106 (FIG. 1). In this configuration, power delivery subsystem 200 provides multiple adjacent mating interfaces for respective PCB connectors to receive power from the bus bar. For simplicity of illustration, PCB connectors mated to those interfaces are shown, but the PCBs are hidden for simplicity of illustration.

As shown in FIG. 2A, portion of a power delivery subsystem 200 includes bus bar modules 202, 204, 206 and 208 aligned end-to-end along an axis of extension 250. These modules each has an extendable interface and a receiving interface, which may be as described above in connection with FIG. 1 such that bus bar modules 202, 204, 206 and 208 are electrically coupled to each other.

In the example of FIG. 2A, a connector 210 is shown in the PCB mating interface of bus bar module 202 for providing a power connection to a first PCB (not shown). A connector 212 is shown in the PCB mating interface of bus bar module 204 for providing a power connection to a second PCB (not shown). A connector 214 is shown in the PCB mating interface of bus bar module 206 for providing a power connection to a third PCB (not shown). A connector 216 is shown in the PCB mating interface of bus bar module 208 for providing a power connection to a fourth PCB (not shown).

FIG. 2A shows four interconnected bus bar modules. In other examples, more or fewer bus bar modules may be chained together in the power delivery subsystem.

A power delivery subsystem may include components not expressly illustrated in FIG. 2A. For example, one or more header bus bar modules may be included at an end of the daisy chain of modules. A header module, for example, may have an interface configured like extendable interface 110 or receiving interface 114, but not both. As a specific example, a header module may have a mating interface for receiving components of the extendable terminal assembly of a neighboring bus bar module but may not itself have an extendable terminal assembly. Alternatively or additionally, a header module may be connected to a power source. In other examples, a header module may mechanically connect to an adjacent bus bar module, but may not make electrical connections to it. Such a header module may block an interface of the adjacent bus bar module.

In contrast, other bus bar modules may be connector bus bar modules. A connector bus bar module may include complementary interfaces, such as both a mating interface for receiving components of the extendable terminal assembly of a neighboring bus bar module and an extendable terminal assembly for mating with a corresponding mating interface of a second neighboring bus bar module.

In the example illustrated in FIG. 2A, bus bar modules 204, 206, and 208 are connector bus bar modules, and bus bar module 202 is a header module. Bus bar modules 204, 206, and 208 include tabs for controlling the position of their respective extendable terminal assemblies. Bus bar module 204 includes tab 220 for controlling the position of the respective extendable terminal assemblies. When in the extended position, the extendable terminal assembly extends beyond the housing of bus bar module 204 to mate with header bus bar 202. Bus bar module 206 includes tab 222 for controlling the position of the respective extendable terminal assembly. When in the extended position, the components of the extendable terminal assembly extend beyond the housing of bus bar module 206 to mate with bus bar module 204. Bus bar module 208 includes tab 224 for controlling the position of the respective extendable terminal assembly. When in the extended position, the extendable terminal assembly extends beyond the housing of bus bar module 208 to mate with bus bar module 206.

FIG. 2B is a side view of a portion of the power distribution subsystem 200 of FIG. 2A. The portion illustrated includes bus bar module 208 and a portion of module 206, including a receiving interface. Housings of the bus bar modules are hidden to reveal conductive elements within the bus bar modules.

Bus bar module 208 includes multiple conductive elements providing multiple paths for power through the module. In this example, the conductive elements in all of the power paths are the same, and only a first elongated conductive element 332 is numbered. As, in this example, module 206 is like module 208 and the elongated conductive elements of module 206 are not numbered for simplicity.

The first elongated conductive element 332 includes a first portion extending along a first axis, axis of extension 250 in this example, from a first end to a second end of the electronic assembly. The first portion includes a first mating contact area 338 at the first end and a second mating contact area 334 at the second end. In this example, the first mating contact area 338 and second mating contact area 334 have the same configuration and is formed by multiple compliant beams configured to engage a blade.

The first elongated conductive element further including a second portion 336 extending from the first portion transversely to the first axis and having an end opposite the first portion. The end of the second portion includes a third mating contact area configured to make a power connection to a PCB. In this example, that connection is made through a connector 216.

Connection between first elongated conductive element 332 in bus bar module 208 and a corresponding conductive element in bus bar module 206 is made through a second conductive element. In the example, of FIG. 2B, the second conductive element is a blade 340. Blade 340 includes a first end configured to engage the first mating contact area 338. A second end of blade 340 also includes a mating contact area. Mating contact areas may be formed based on the shape and material of the mating components. For example, a mating contact area may be a surface on a flat structure, such as a blade and a complementary mating contact area may have one or more compliant beams with concave surfaces that are configured to press against a flat structure. Plating or surface treatments may also be preferentially applied to the mating contact areas.

In some examples, the second conductive element, such as blade 340, may be pivotally mounted in the connection module such that the mating contact area at the second end of the second conductive element moves in a direction perpendicular to the first axis when the second conductive element pivots.

In the example, of FIG. 2B, the second conductive element may be a portion of an extendable interface and may be mounted in bus bar module 208 to be movable with respect to elongated conductive element 332. Conductive element 332 may be mounted within a first insulative housing of bus bar module 208 and blade 340 may be mounted in a second housing. The second housing may be movable with respect to the first housing, such as by sliding, along a first axis, such as axis of extension 250.

In some embodiments, the second conductive element is slidably mounted in the bus bar module to slide between a position in which the second conductive element is retracted into the connection module to enable the connection module to be inserted between a second like connection module and a third like connection module; and a position in which the second conductive element is extended into the second like connection module.

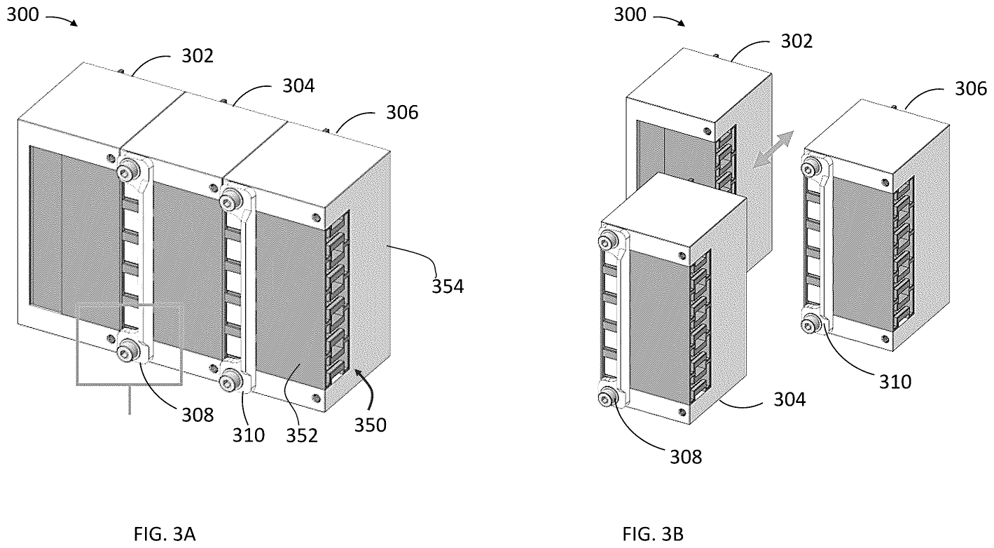

FIG. 3A is a perspective view of a portion of a power delivery subsystem 300 in an assembled configuration, in accordance with some embodiments of the technology described herein. Power delivery subsystem 300 includes bus bar modules 302, 304, and 306. These modules may include any or all of the features described above. In this example, bus bar module 302 is a header module. Bus bar modules 304 and 306 are connection modules. Each of bus bar modules 302, 304, and 306 may include a receiving interface 350, exposed on a first side of a first housing 352.

Bus bar modules 304 and 306 include tabs 308 and 310, respectively. These tabs may serve the same function as tab 112 (FIG. 1). In this example, tab 308 is coupled to a second housing forming a portion of an extendable terminal assembly. Tab 308 may be coupled to the second housing in any suitable way. For example, the second housing may be molded from plastic, nylon, PVC or other insulative material and tab 308 may be integrally molded with the second housing. In other examples, tab 308 may be a separate component connected to the second housing.

Optionally, the first housing 352 may be held in a support structure, such as an outer housing 354. In this example, the support structure provides mechanical support and electrical connections are made through conductive elements within the first and/or second housings.

When tab 308 is in an engaged position, conductive elements of the extendable terminal assembly extend from bus bar module 304 into the receiving interface of bus bar module 302 for mating. When tab 310 is in an engaged position, conductive elements of the extendable terminal assembly extend from bus bar module 306 into the receiving interface of bus bar module 304 for mating. Accordingly, when modules are placed side-by-side and tabs 308 and 310 are each in an extended position, bus bar modules 302, 304, and 306 are electrically coupled together.

FIG. 3B is a perspective view of the portion of the power delivery subsystem 300 in a disassembled state. When tab 308 is in a retracted position, the conductive elements of extendable terminal assembly are retracted into bus bar module 304. Similarly, when tab 310 is in a retracted position, the conductive elements of the extendable terminal assembly are retracted into bus bar module 306. Accordingly, when both tab 308 and tab 310 are in retracted positions, bus bar module 304 may be removed from configurable bus bar 300 by laterally sliding bus bar module 304 away from bus bar modules 302 and 306. Similarly, for assembling, bus bar module 304 may be laterally slid between bus bar modules 302 and 306 when the extendable terminal assemblies are in the retracted positions.

In some embodiments, a bus bar module may include a mechanism for locking the second housing into one or more positions. In the example of FIGS. 3A and 3B, the second housing includes a screw configured to lock the second housing in one of two positions, such as an extended and a retracted position. The second housing may include a hole through which a screw passes to engage with a corresponding tapped hole in the outer housing. The holes may be positioned to secure the second housing in any of one or more predetermined positions. In this example, the screw passes through the tab that protrudes from the first housing 352 to facilitate user engagement with the second housing.

Alternatively or additionally, a module may include one or more latching elements that will secure the second housing relative to the first housing of the module and/or a support structure such as outer housing 354. As another example, the second housing may include a latch configured to lock the second housing in an extended position.

The bus bar module includes a mating face and at least a first conductive element held within the housing. An extendable terminal assembly may include a second housing that is movably coupled to the first housing, such that the second housing is movable between at least a first position with respect to the first housing, such as a retracted position, and an extended position with respect to the first housing, such as an extended position. In the position, the second conductive element may be retracted into the first housing by a sufficient amount that the first housing blocks unintended contact between a human finger and the second conductive element such that the second conductive element is guarded by the first housing when the second housing is in the first position, e.g., an unmated position. When the second housing is in the extended position, the second conductive element may be exposed for mating with at least one mating component at the mating face.

To provide electrical connectivity and mating through the extendable terminal assembly, a second conductive element may be mounted in the second housing. That second conductive element may be movably mounted in the second housing to accommodate misalignment of adjacent bus bar modules.

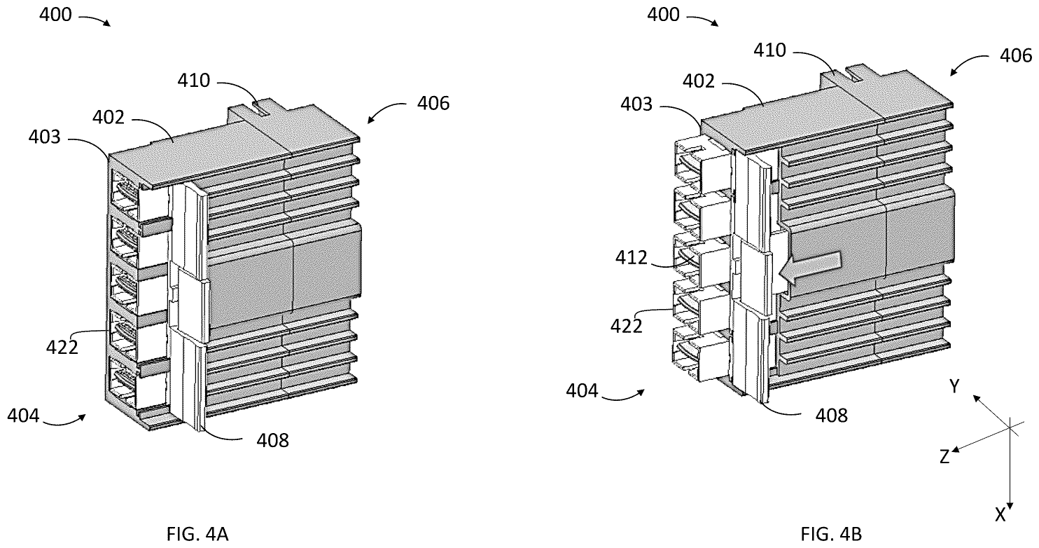

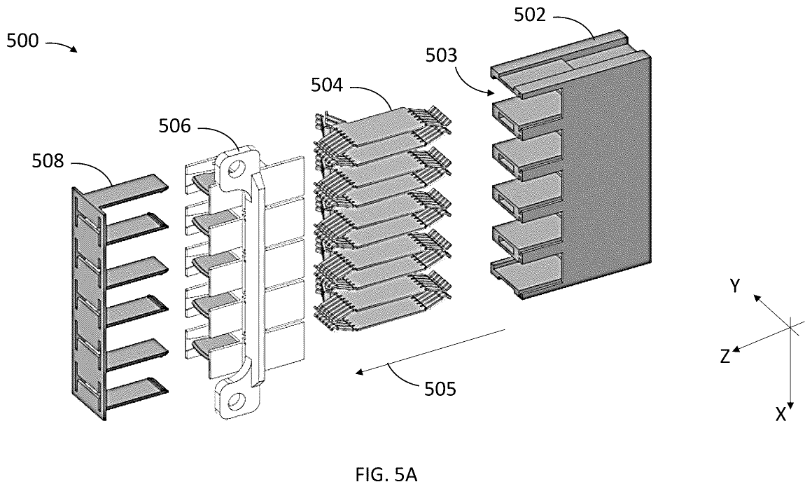

FIG. 4A is a perspective view of a bus bar module 400 with a sliding portion in a retracted position, in accordance with some embodiments of the technology described herein. In this example, bus bar module 400 may represent a connection module as described above, such as modules 204, 206 or 208 (FIG. 2A). For simplicity of explanation, only conductive elements forming a first conductive path within the bus bar module is described, but, as can be seen in FIGS. 4A and 4B, there may be multiple such conducting paths.

Bus bar module 400 includes module housing 402, a second housing 422 forming a portion of an extendable terminal assembly 404, and a mating interface 406 for receiving components of another bus bar module. Extendable terminal assembly 404 includes tab 408 which extends beyond housing 402 such that the tab 408 can be accessed by a user. In the state shown in FIG. 4A, tab 408 is in a retracted position such that the extendable terminal assembly is in a retracted position. While in the retracted position, the extendable terminal assembly is withdrawn into housing 402. In the example of FIG. 4A, neither the second housing 422 or the conductive elements within the second housing extend beyond a mating face 403 of the first housing.

When the second housing is in the second position, which in this example is the extended position, a mating contact area of a second conductive element 412 extends through the mating face of the first housing. The exposed mating contact area may then be received by the mating interface of a neighboring connector such that the exposed mating contact area engages with a third conductive element, thereby electrically coupling the third conductive element to the first electrically conductive element.

The second housing is movably coupled to the first housing to facilitate movement between the position for mating and the position for unmating. In some embodiments, the second housing is movably coupled to the first housing such that the second housing slides relative to the first housing along a first axis. The first axis being the mating axis along which the mating elements extend, and the mating axis being aligned with the long axis of the connector.

FIG. 4B is a perspective view of the bus bar module 400 of FIG. 4A with the sliding portion in an extended position, in accordance with some embodiments of the technology described herein. Bus bar module 400 includes the same components as described above in connection with FIG. 4A. Relative to the configuration in FIG. 4A, the configuration shown in FIG. 4B illustrates portions of the extendable terminal assembly 404 extended from housing 402 such that the extendable terminal assembly 404 is in an extended position. As shown in FIG. 4B, tab 408 is in a forward position such that the extendable terminal assembly is in an extended position. While in the extended position, the extendable terminal assembly is extended with components protruding from the front of assembly housing 402. The extendable terminal assembly includes conductive elements 412 movably mounted within the extendable terminal assembly. The conductive elements 412 are configured to electrically couple conductive elements within housing 402 to a neighboring module. In this example, conductive elements 412 are configured as blades that mate with mating contact portions of other conductive elements shaped as spring fingers.

In the example of FIGS. 4A and 4B, the second housing 422 includes walls surrounding the conductive element 412. These walls may be insulative and may block contact to conductive element 412, even when extended from the first housing. In this example, each receiving interface may receive both a conductive element 412 and portions of the second housing extending beyond the mating face of the first housing when the extendable terminal assembly is in an extended position.

The conductive element 412 may be movably mounted such that the second conductive element can engage with the second mating contact area of the first conductive element of a neighboring connection module when the first axis of the neighboring connection module is offset from the first axis of the bus bar module. In some embodiments, the offset between the first axis of bus bar module and a neighboring connection module that can be accommodate by movement of the conductive element 412 may be between 0 and 1.0 mm, between 0 and 0.8 mm, between 0 and 0.7 mm, between 0 and 0.5 mm, between 0 and 0.2 mm, or between 0 and 0.1 mm. For example, movement of the conductive element 412 may accommodate an offset between the first axis of the bus bar module and a neighboring connection module up to at least 0.7 mm.

In some embodiments, the connector includes multiple conductive elements. The multiple conductive elements include first and second groups of conductive elements. The first group of conductive elements may be held within the first housing. The first group of conductive elements are arranged along the X-axis that is perpendicular to the Z-axis. The second group of conductive elements are held within the second housing. The second group of conductive elements may be arranged along an axis parallel to the X-axis. The second housing is movably coupled to first housing such that the second housing slides relative to the first housing along the Z-axis.

FIG. 5A is an exploded view of bus bar module 500, in accordance with some embodiments of the technology described herein. Bus bar module 500 may represent, for example, bus bar module 304 or 306, without outer housing 354 (FIG. 3A). Bus bar module 500 includes a first and a second housing, which may be movable relative to the first housing. In this example, the first housing includes two pieces, module housing 502 and front housing plate 508. Conductive elements, here shown as electrical contacts 504 are held within the first housing. Additionally, bus bar module 500 includes extendable terminal assembly 506, which in this example includes a second housing and second conductive elements that engage electrical contacts 504, at least when extendable terminal assembly 506 is extended for mating with an adjacent module.

When assembled, electrical contacts 504 are disposed in module housing 502. Extendable module assembly 506 is disposed in module housing and front plate 508 attaches to module housing 502. The extendable terminal assembly 506 is configured to move within the module housing 502 such that the extendable terminal assembly may be adjusted between a retracted, unmated configuration and an extended, mated configuration.

In some embodiments, the housing 502 includes a first member bounding a cavity, the cavity 503 having an opening and a cover 508 over the opening. The cover 508 may be positioned on any side of the housing. In some embodiments, the cover may define a mating face of the housing. As a mating face, the cover may include an opening such that the second conductive element extends through the opening when the second housing is in the extended position.

FIG. 5B is an exploded view of an alternative embodiment of a bus bar module 510, in accordance with some embodiments of the technology described herein. Bus bar module 510 may be an example of bus bar module 400 (FIGS. 4A and 4B). Bus bar module 510 differs from bus bar module 500 in the shape of the first housing and the shape of the second housing. In this example, bus bar module 510 has a first housing that includes rear module housing 512 and front module housing 516. Extendable terminal assembly 518 has a second housing, slidably mounted in the first housing, with conductive elements movably held in the second housing. Electrical contacts 514 may function like terminals 504, but in this example are longer in an insertion direction. Additionally, the position of the mating contact portions for engaging with a PCB have a different position relative to the ends of the terminals.

When assembled, electrical contacts 514 are disposed with rear housing 512 and front housing 516. The extendable terminal assembly is movably configured in the front module housing 516 such that the extendable terminal assembly may be adjusted between a retracted configuration where electrically conductive blades of the extendable terminal assembly are retracted within the front module housing 516 and an extended position where the electrically conductive blades extend beyond front module housing 516 such that the electrically conductive blades may electrically couple the electrical contacts 514 of the bus bar module with corresponding electrical contacts in a neighboring bus bar module.

While disposed within the front module housing 516 and rear module housing 512, the electrical contacts 514 are configured to mate with a corresponding PCB through apertures in the back module housing 512. In some embodiments, the contacts extend perpendicular to the bus axis 505 of the bus bar module. For example, the contacts may extend along the Y-axis. The bus axis may be parallel with the Z-axis, as shown in the example of FIG. 5A. The bus axis need not be oriented parallel with the Z-axis, as aspects of the technology described herein are not limited in this respect.

To operate an electronic system including multiple bus bar modules, the bus bar modules are first interconnected. To interconnect two bas bar modules, a first bus bar module, configured as a connection module, is positioned adjacent to a second connection module with a receiving interface. The first connection module may be offset from the second connection module in one or more directions. Following positioning of the first and second connection module, interconnection includes moving a mating contact portion of the first bus bar module into engagement with the second connection module along a first axis, e.g., a bus axis. To facilitate mating despite misalignment of the bus bar modules in a direction perpendicular to the first axis, the contact portion may be compliant in that direction perpendicular to the first axis. Once interconnected, operating the electric systems may include flowing current through the one or more sequentially connected connection modules to each of respective PCBs coupled to one of the assembled connection modules.

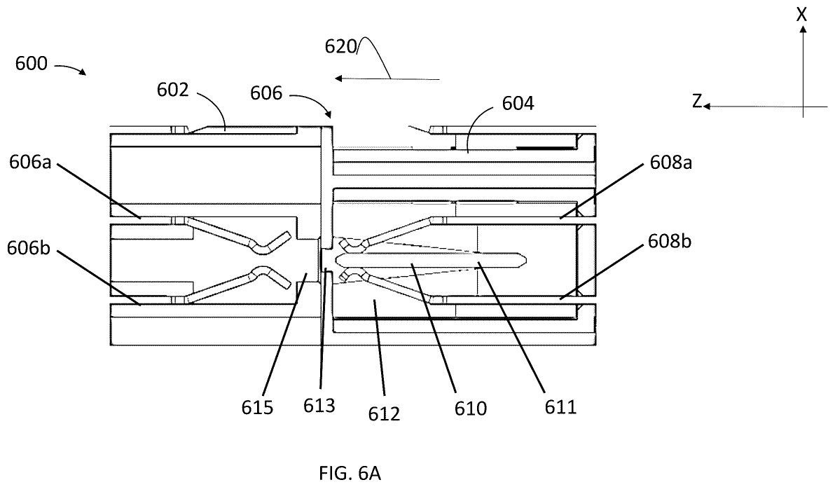

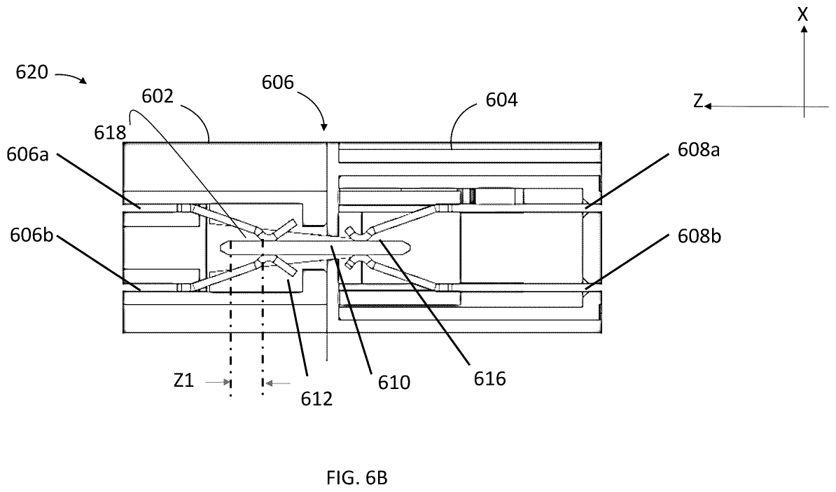

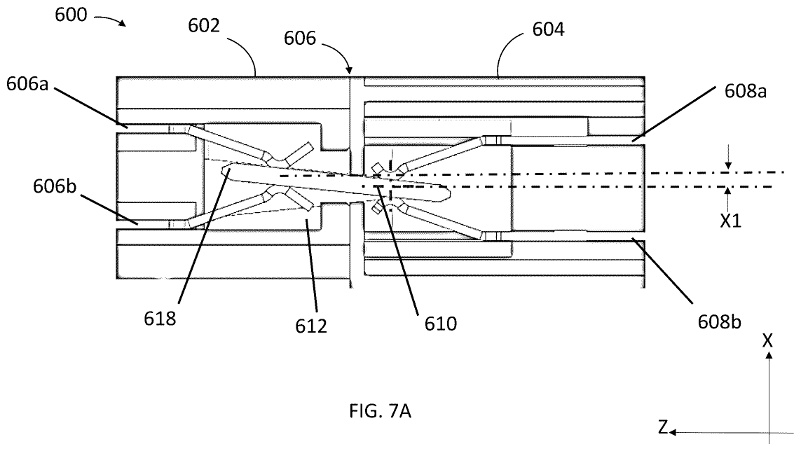

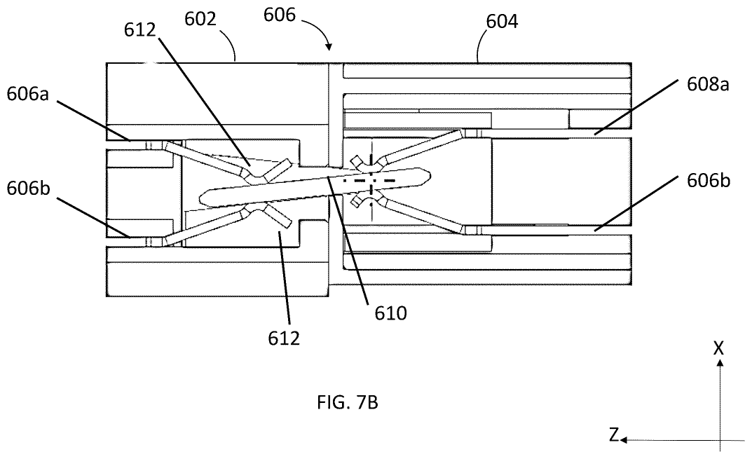

An example of such a method of interconnection of two bus bar modules is illustrated in FIGS. 6A and 6B, and an example of accommodation for offset is illustrated in FIGS. 7A and 7B. FIG. 6A illustrates in cross section a portion of a power delivery subsystem 600 that includes portions of two bus bar modules 602 and 604. Modules 602 and 604 may represent any of the modules described herein with a receiving interface and an extension interface, respectively. In this example, at least module 604 is a connection module and the portions shown include the portion of an extension interface of module 604. The portion of module 602 includes a portion of a receiving interface.

The receiving interface of module 604 includes an end of a first conductive element that terminates in electrical contacts 608a and 608b, here shown configured as beams. A second conductive element, here shown as a blade 610 is shown between contacts 608a and 608b. The mating contact area of the second conductive element may be configured as a blade, in accordance with some embodiments of the technology described herein. The first mating contact area of the first conductive element 608a and the second mating contact area of the first conductive element 608b each include opposed compliant members shaped to receive the blade 510. In some embodiments, the first mating contact area includes multiple compliant members.

Blade 610 is movably mounted to extendable module housing 612 at pivot 611, such that the blade may pivot relative to the housing around pivot 611. The extendable module housing 612 and blade 610 are configured to move along axis of extension 620 through mating interface 606. The beams of electrical contacts 608a and 608b are mounted to remain in place such that the extendable module housing moves relative to electrical contacts 608a and 608b when moving along the axis of extension 620. Blade 610 slides between electrical contacts 608a and 608 such that the beams maintain an electrical contact with blade 610 as blade 610 moves along the axis of extension 620. The housing of module 604 includes an aperture 613 through which blade 610 passes through when extended along axis of extension 620 for mating with module 602.

The receiving interface of module 602 includes an end of a first conductive element that terminates in electrical contacts 606a and 606b, here shown configured as beams. Electrical contacts 606a and 606b are configured to receive a second conductive element, here shown as blade 610 between the electrical contacts 606a and 606b. When receiving blade 610, the housing of module 602 may include aperture 615 through which blade 610 is received. In some examples, aperture 615 may be sized differently than aperture 613. Aperture 615 may be larger than aperture 613 to receive blade 610 even when there is misalignment between module 602 and module 604.

Electrical contacts 608a and 608b are configured such that blade 610 may slide between them, when moving along axis of extension 620 such that electrical contacts 608a and 608b are in electrical contact with blade 610. For example, electrical contacts 608a and 608b may be configured to receive blade 610 directly between the two electrical contacts. Electrical contacts 608a and 608b may be further configured to also receive blade 610 at a vertical offset from the center of receiving aperture 615 such that when the module 604 and module 602 are not aligned along the X-axis, mating between the two modules through electrical contact between electrical contacts 606a and 606b with blade 610 may still occur.

Blade 610, electrical contacts 606a and 606b, and 608a and 608b are configured to accommodate misalignment of the modules in the Z direction. The length of blade 610 and the range of movement along the axis of extension 620 is such that, if there is a misalignment between module 604 and module 602 along the Z-axis, blade 610 may still provide electrical contact between electrical contacts 606a and 606b in one module and electrical contacts 608a and 608b in another module. The electrical contacts 606a and 606b are configured to make electrical contact along the length of blade 610 such that depending on the degree of insertion of blade 610 into module 602, electrical contacts 606a and 606b maintain electrical conductivity with blade 610. Similarly, electrical contacts 608a and 608b are configured to make electrical contact along the length of blade 610 such that depending on the on the degree of insertion of blade 610 into module 602, electrical contacts 608a and 608b maintain electrical conductivity with blade 610.

In some embodiments, the first conductive element 608a and 608b includes a bar extending along the first axis between the first mating contact area and the second mating contact area. The bar extending between the first and second mating contact areas electrically connects the first mating contact area and the second mating contact area. The electrical contacts 606a and 606b may be a corresponding second end of the electrical contacts 608a and 608b, where the two sets of electrical contacts are configured at opposing ends of the bus bar module.

For mating between module 604 and 602, the extendable module housing 612 and blade 610 move from a retracted position, shown in FIG. 6A to an extended position in which the conductive element to facilitate power transfer engages both the electric contacts of the first module and the electric contacts of the second module, as shown in FIG. 6B. During assembly of a power distribution subsystem from modules as described herein, the mating contact portion of the conductive element configured to facilitate power transfer is moved from the retracted position to the extended position. In some embodiments, the conductive element to facilitate power transfer may be locked into the extended position, as described herein.

In some examples, positioning the first connection module adjacent to a second connection module can be achieved by inserting the first connection module in a gap between the second connection module and a third connection module, as is illustrated in FIG. 3B.

FIG. 6A is a cross section of a portion of a first bus bar module 602 adjacent a portion of a second bus bar module 604, with a sliding portion of the first bus bar module in a retracted position, in accordance with some embodiments of the technology described herein. In the state illustrated, bus bar module 602 and bus bar module 604 is unmated but aligned with each other. As shown in FIG. 6A, the extension interface of bus bar module 602 is aligned with the receiving interface of bus bar module 602 such that blade 610 is aligned, along an axis of extension 620, with the mating contact portion of the conductive element in the receiving interface of bus bar module 602. In this example, blade 610 is centered between electrical contacts 606a and 606b which form opposing sides of the mating contact portion.

FIG. 6B is a cross section of the portions of the first bus bar module and the second bus bar module of FIG. 6A, with the sliding portion of the first bus bar module in an extended position, in accordance with some embodiments of the technology described herein. As shown in FIG. 6B, the extendable terminal assembly is in an extended state such that blade 610 engages contacts 606a and 606b and 608a and 608b. In this state, blade 610 electrically couples electrical contacts 606a and 606b to electrical contacts 608a and 608b.

Blade 610 is sized and otherwise configured such that, when moved into the extended position, electrical contacts 606a and 606b contact mating contact area 618 and electrical contacts 608a and 608b contact mating contact area 616 of blade 610 when modules 602 and 608 abut one another. Modules 602 and 608 may be designed to operate in this state or other state in which there is a nominal separation other than 0 between the modules in the direction of the axis of extension 620, which aligns with the direction denoted Z in FIG. 6B.

An electrical connection may be formed even if the modules are not positioned with the nominal separation in the direction of the axis of extension 620. In the example illustrated, mating contact area 618 extends, in the direction of the axis of extension 620, an amount Z1 beyond the area in which contacts 606a and 606b engage the mating contact area 618. If modules were misaligned such that there was more than the nominal separation between them, the contacts may still engage if that separation was up to a distance Z1. The distance Z1, and therefore the supported misalignment in the direction of the axis of extension 620, may be up to 1 mm, 5 mm, 7 mm, 8 mm or 10 mm, in some examples. In some examples, the range of travel is between 1 and 40 mm, 1 and 30 mm, or 1 and 15 mm.

Module designs as described herein may also support misalignment in other directions. In some examples, a second conductive element forming a portion of the extension interface of a module may be movably mounted to a second housing of the module that moves in a direction parallel to the axis of extension 620. With such movement the mating contact area of the second conductive element, mating contact area 618 in the pictured example, may move in a direction transverse to the axis of extension 620 to accommodate misalignment. FIG. 7A is a cross section of the portions of the first bus bar module and the second bus bar module of FIG. 6B, with the sliding portion of the first bus bar module in an extended position and an offset between the first and second bus bar modules perpendicular to the sliding axis, in accordance with some embodiments of the technology described herein. In the example of FIG. 7A, misalignment creates an offset of X1. Blade 610 is mounted in housing 612 to be movable such that the movement of blade 610 can compensate for the misalignment between bus bar module 602 and bus bar module 604 creating the offset of X1. As shown in FIG. 7A, blade 610 is at an angle relative to the axis of extension 620 of the bus bar such that blade 610 angles up towards the electrical contacts 606a and 606b. In this configuration mating contact area 616 engages contacts 608a and 608b and mating contact area 618 engages contacts 606a and 606b. This configuration may be created by a movable mounting of blade 610 in housing 612, such as a mounting that enables blade 610 to pivot into the position illustrated.

Blade 610 may be movably mounted to enable motion of the mating contact area 618 in one or more directions relative to its nominal position shown in FIG. 6B. FIG. 7B is a cross section of the portions of the first bus bar module and the second bus bar module of FIG. 6B, with the sliding portion of the first bus bar module in an extended position and an offset between the first and second bus bar modules perpendicular to the sliding axis and in a direction opposite to that shown in FIG. 7A, in accordance with some embodiments of the technology described herein., In this state, blade 610 is at an angle relative to the mating axis of the bus bar such that blade 10 angles down towards the electrical contacts 606a and 606b. Motion up or down as shown in FIGS. 7A and 7B accommodates for misalignment of the mated modules in either direction along the axis indicated as X direction in FIG. 7B. The amount of misalignment may depend, at least in part, on the range of relative motion of the portions of the mating contact portions that engage contacts 606a and 606b and contacts 608a and 608b.

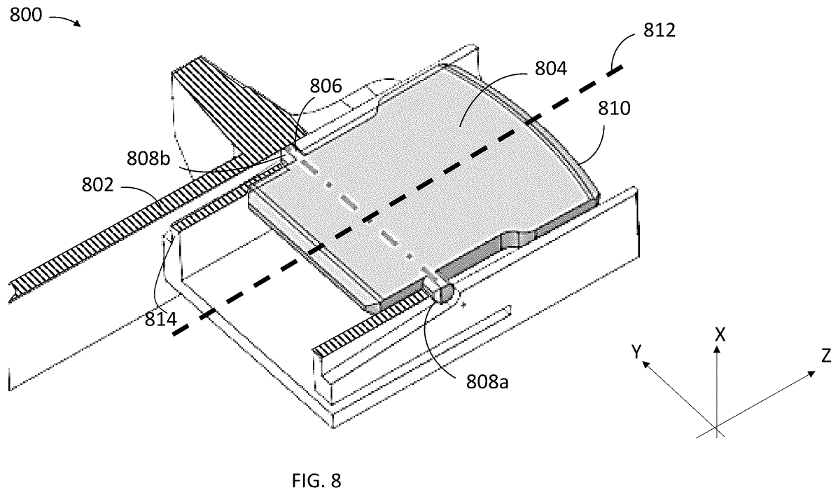

FIG. 8 is a perspective view of a portion of extendable assembly 800, in accordance with some embodiments of the technology described herein. Extendable assembly 800 may be extendable assembly 506 (FIG. 5A), but the mounting techniques described in connection with extendable assembly 800 may be applied to extendable assembly 518 (FIG. 5B), extendable assemblies in other configurations, or to movably mounting a second conductive element in a housing, whether or not the housing is movable along an axis of extension. In this example, extendable assembly 800 includes extendable assembly housing 802 and blade 804. FIG. 8 shows extendable assembly 800 with portions cutaway to reveal a conductive element pivotably mounted in the extendable assembly. Extendable assembly housing 802 is configured to support blade 804 such that blade 804 rotates within the housing. Blade 804 is configured in extendable assembly housing 802 to rotate around axis 806. To facilitate rotation around axis 806, blade 804 includes projection 808a and 808b extending from the sides of blade 804. Extendable assembly housing includes grooves for receiving protrusions 808a and 808b such that the protrusions rotate within the grooves of the extendable assembly housing 802 when the front edge 810 of the blade 804 deflects up or down at the front of extendable assembly housing.

is the movable mounting illustrated in FIG. 8 enables blade 804 to pivot about a second axis 806 transverse to the first axis 812. In the example, the axis 812 aligns with axis of extension 620. In this example, the second axis is perpendicular to the first axis. In other examples, the second axis may be approximately perpendicular to the first axis. As yet another example, the second axis may be out-of-plane with the mating axis at an angle between 0 degrees and 45 degrees.

In the example, of FIG. 8, projections 808a and 808b of blade 810 are in grooves that are bounded to the rear by sidewalls 814 of the housing 802. Those sidewalls constrain movement of blade 810 relative to housing 802 along axis 812 in a direction corresponding to the −Z direction, according to the axes superimposed on FIG. 8. In this example, sidewalls may also have features that restrict projections 808a and 808b from being removed from the grooves even if pulled in the +Z direction with respect to housing 802. The sidewalls, for example, may have features that flex to clear a path for projections 808a and 808b to be inserted into the groove, but snap back into position to block removal of projections 808a and 808b from the grooves.

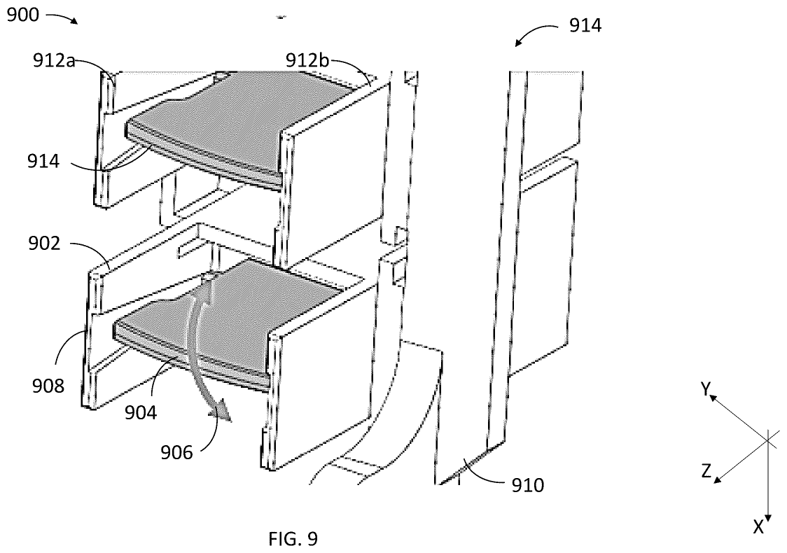

FIG. 9 is a perspective view of a portion of the extendable assembly of FIG. 5A, in accordance with some embodiments of the technology described herein. Extendable assembly 900 may be extendable assembly 800 (FIG. 8), but the structures and features described in connection with extendable assembly 900 may be applied to extendable assembly 518 (FIG. 5B), extendable assemblies in other configurations, or to movably mounting a second conductive element in a housing, whether or not the housing is movable along an axis of extension.

In the example of FIG. 9, extendable assembly 900 includes side wall 902 of extendable assembly 900, blade 904, side wall 912 of extendable assembly 900, blade 914, and tab 910. The portion of the extendable assembly shown includes multiple blades configured between insulating side walls. In some embodiments, the blades are configured stacked one on top of another in a column, as shown in FIG. 9. In other examples, the blades may be positioned side-by-side in one or more rows.

The extendable assembly housing may be configured to prevent lateral movement of the second conductive element along the second axis. The second axis may be along a width direction of the housing, such as axis 806 shown in FIG. 8. For example, side walls may be included as part of the second housing which constrain lateral movement of the second conductive element along the second axis while permitting the second conductive element to rotate along an axis within the housing. For example, side walls 912a and 912b may be configured to prevent lateral movement of the blade 904 along the second axis.

Optionally, the assembly housing may include features that block inadvertent contact, such as by a human finger, to the conductive blades when extended out of the module housing. In the example of FIG. 9, those features are shaped as insulative blades, including a first insulative blade 912a and a second insulative blade 912b. These blades are configured to extend through the mating face of the connection module when the extendable assembly housing is in an extended position. In the example of FIG. 9, there are insulative blades are on opposite sides of each of the conductive blades. In other examples, such as is shown in connection with extendable assembly 518 (FIG. 5B), there may be more than two insulative blades, such as four insulative blades bounding four sides of the conductive blade. Those insulative blades may be separate or some or all may be fused. In the example of FIG. 5B, insulative blades on four sides of each blade are fused into a closed perimeter, forming an insulative surround bounding the blade.

Side walls of the extendable assembly housing are configured to support the blades of the extendable assembly. The sidewalls, including the extending blades 902, may be configured to enable movement of blade 904 with respect to the extendable assembly housing. The side walls, for example, may include grooves, such as groove 908, which are shaped to provide clearance for the blade when it pivots with a motion indicated by line 906. In this example, the grooves wedge-shaped, narrower near the pivot point of the blade and wider near the front end of the extendable assembly. Alternatively or additionally, the groove may function as a guide to limit the extent of the deflection of the blade and/or may guide protrusions on the blades (such as protrusions 808a and 808b (FIG. 8), into a location where then can be coupled to the housing.

The movability of the blade is configured to enable engagement between the blade and electrical contacts of a neighboring connector over a range of misalignment between the bus bar module including the blade and the neighboring connector.

As shown in FIG. 9, the blade is configured to pivot to accommodate engagement with a connection module at a location in a range of locations. In some embodiments, the range of locations is between 0 to 5 mm, 0 to 3 mm, 0 to 2 mm, or 0 to 1 mm. For example, the range of locations is between 0 and 1.5 mm, where a range of 0 mm corresponds to alignment between the blade and the connection module such that the blade need not pivot for mating. As shown in FIG. 9, the blade is configured to pivot to accommodate engagement with a connection module at a location in a range of locations. In some embodiments, the range of locations is between 0 to 5 mm, 0 to 3 mm, 0 to 2 mm, or 0 to 1 mm. For example, the range of locations is between 0 and 1.5 mm, where a range of 0 mm corresponds to alignment between the blade and the connection module such that the blade need not pivot for mating.

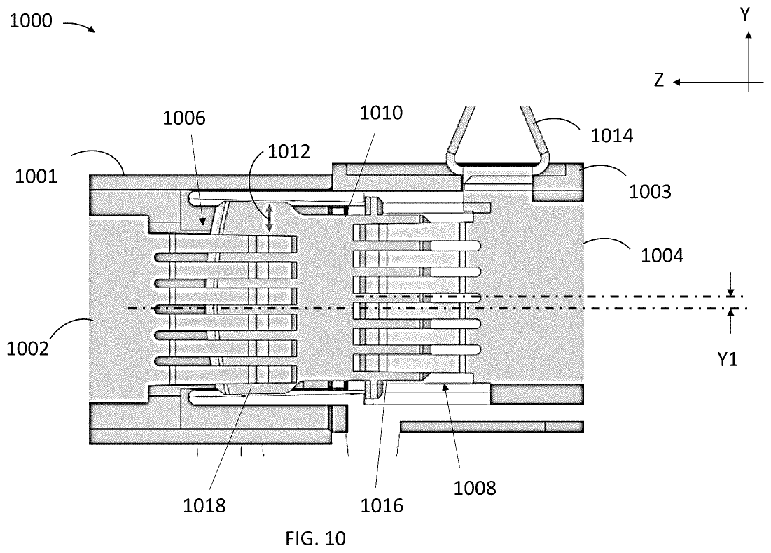

Connectors as described herein may alternatively or additionally be configured to accommodate misalignment in a further direction. Techniques as described above may enable mating of bus bar modules despite misalignment in the directions labeled Z and X. FIG. 10 illustrates a design technique that may enable mating despite misalignment in the direction labeled Y. In the example illustrated, misalignment between adjacent bus bar modules has resulted in an offset of Y1.

FIG. 10 i ortions of the module housings are cut away to reveal mating contact portions at the end of the conductive elements within the bus bar modules. In the state shown bus bar module 1001 is mated with bus bar module 1003. Bus bar module 1003 may be any connection module with an extension interface as described herein. Bus bar module 1001 has a receiving interface and may represent any bus bar module as described herein with a receiving interface.

When mated, bus bar modules 1001 and 1003 are electrically coupled through blade 1010. Blade 1010 provides electrical connectivity between electrical conductors 1002 and 1004. Bus bar module 1003 further includes contacts 1014 for providing power to a PCB, such as by mating with a connector on the PCB as described herein.

Electrical conductor 1002 has a mating contact area formed by multiple beams 1006 for mating with blade 1010. Similarly, electrical conductor 1004 has a mating contact area formed by multiple beams 1008, also configured for mating with beam 1010. Blade 1010 includes a mating contact area 1018 for mating with conductor 1002. The mating contact areas of conductor 1002 and/or blade 1010 may be configured to accommodate for an offset between bus bar modules 1001 and 1003.

In the state shown, the offset between bus bar modules 1001 and 1003 is Y1 with no impact on the mating between beams 1006 and mating contact area 1018. In the example of FIG. 10, the mating contact area 1018 of blade 1010 is wider than the mating contact area of the beams 1006. As a result, even though the modules are offset by an amount Y1, all of the beams 1006 contact mating contact area 1018.

In the state shown, there is a separation of 1012 between the end of the mating contact region of the beam 1006 and the end of mating contact region 1018 of blade 1010. All of the beams 1006 would similarly contact mating contact area 1018 even if the offset were such that the space 1012 were smaller. Accordingly, based on the extra width, blade 1010 can accommodate a range of offsets, such as might result from a misalignment between mated modules, in the direction labeled Y. That range of offsets may be between 0 to 2 mm, 0 to 1 mm, or 0 to 0.5 mm. For example, the range of misalignment may be between 0 to 0.8 mm. In examples in which the offset may be in either direction relative to a nominal position, the range of offsets may alternatively be express as a magnitude of half the total range, but may be expressed as a positive or negative offset. As a specific example, the range of offsets may be +/−0.4 mm.

In the example illustrated, the mating contact area of conductor 1004 has the same configuration as the mating contact area of conductor 1002. With this configuration, the beams 1008 have a mating contact area having a first width, here shown in the Y direction. Blade 1010 includes a second mating contact area 1018 having a second width, also in the Y direction. The first width and the second width are different, with the second width being larger in this example. For example, the blade which is movably mounted in the second housing may be wider across the second axis than the width of the electrical contacts 1008 which engages with the blade such that the first mating contact area of the electrical contacts 1008 and the second mating contact area of the electrical contacts 1006, are electrically coupled together. In some embodiments, the first width of the first mating contact area and the second width of the second mating contact area may be the same width.

Optionally, blade 1010 is wider at the front mating side (e.g., the side that mates with electrical connector), than the width of the blade at the contact points in the back. In the example of FIG. 10, blade 1010 is wider at the front of the blade, (e.g., the side that makes contact with electrical contacts 1006) than it is in mating contact area 1016, which makes contact with beams 1008 of conductor 1004.

### Example Embodiments

One or more of the design techniques described herein may be embodied in bus bar modules that can accommodate misalignment between modules such that adjacent bus modules may maintain power connectivity, even when misaligned. These modules may include connectors as described herein.

An example connector includes a connector configured for mating with at least one mating component, the connector comprising: a first housing having a mating face; a first conductive element held within the first housing; a second housing movably coupled to the first housing such that the second housing is movable between at least a first position with respect to the first housing and a second position with respect to the first housing; and a second conductive element movably mounted in the second housing and positioned to be guarded by the first housing when the second housing is in the first position and to engage with the first conductive element and be exposed for mating with the at least one mating component at the mating face when the second housing is in the second position.

Optionally, such a connector may include one or more of the following features: the second housing movably coupled to the first housing such that the second housing slides relative to the first housing along a first axis; a screw configured to lock the second housing in the second place; the second conductive element comprises a mating contact area, and the second conductive element is movably mounted to the second housing such that the mating contact area moves in a direction transverse to the first axis; the second conductive element is movably mounted to the second housing such that the second conductive element pivots about a second axis transverse to the first axis; the second axis is perpendicular to the first axis; the second conductive element is movably mounted to the second housing such that motion of the mating contact area along the first axis is constrained in at least one direction; the first conductive element comprises a first mating contact area having a first width along a second axis, the second conductive element comprises a second mating contact area having a second width along the second axis, the second conductive element engages the first conductive element at the first mating contact area and the second mating contact area, and the second width and the first width are different; the second width is larger than the first width; when the second housing is in the first position, the second conductive element is within the first housing, and when the second housing is in the second position, the second conductive element extends through the mating face of the first housing; when the second housing is in the second position, a mating contact area of the second conductive element extends through the mating face of the first housing; the first conductive element comprises a plurality of beams configured to engage the second conductive element, the plurality of beams defining a mating contact area of the first conductive element extending along a second axis, perpendicular to the first axis, for a first width, and the mating contact area of the second conductive element extends along the second axis by a second width which is greater than the first width by at least 0.7 mm; the mating contact area of the second conductive element is at a second end, the second conductive element has a first end, opposite the second end, and the first conductive element engages the second conductive element at the second end of the second conductive element and the first end of the second conductive element comprises a further mating contact area; the second housing is movably coupled to the first housing such that the second housing moves relative to the first housing along a first axis, the first conductive element comprises a first mating contact area positioned to engage the second conductive element when the second housing is in the second position, and the first conductive element comprises a second mating contact area opposite the first mating contact area along a first axis; the first conductive element comprises a third mating contact area extending perpendicular to the first axis; the third mating contact area of the first conductive element is configured for mating with a card edge of a printed circuit board; the second conductive element has a mating contact area configured as a blade, and the first mating contact area of the first conductive element and the second mating contact area of the first conductive element each comprise opposed compliant members shaped to receive the blade; the third mating contact area is positioned closer to the second mating contact area than the first mating contact area along the first axis; the first conductive element further comprises a bar extending along the first axis between the first mating contact area and the second mating contact area, and electrically connecting the first mating contact area and the second mating contact area; the first mating contact area comprises a plurality of compliant members, and the second mating contact area comprises a blade; the first housing comprises a first member bounding a cavity comprising an opening and a cover over the opening, and the cover comprises the mating face; the cover comprises an opening, and the second conductive element extends through the opening when the second housing is in the second position; the second housing comprises a first insulative blade and a second insulative blade that extend through the mating face on opposite sides of the second conductive element when the second housing is in the second position; the second housing comprises an insulative surround for the second conductive element, the insulative surround comprising the first insulative blade and the second insulative blade; the connector comprises a plurality of first conductive elements, including the first conductive element, held within the first housing, and the connector comprises a plurality of second conductive elements, including the second conductive element, held within the second housing; the first conductive elements of the plurality of first conductive elements are arranged along a second axis perpendicular to the first axis, and the second conductive elements of the plurality of second conductive elements are arranged along an axis parallel to the second axis; the first housing is configured to guard the bar and comprises a second opening, and the second mating contact area of the first conductive element is exposed through the second opening.

A second example connector includes a connection module for an electronic assembly configured to engage with a like connection module and a printed circuit board, the connection module comprising: a first conductive element comprising: a first portion extending along a first axis from a first end to a second end, the first portion comprising a first mating contact area at the first end and a second mating contact area at the second end; and a second portion extending from the first portion transversely to the first axis and having an end opposite the first portion, the end of the second portion comprising a third mating contact area configured to engage a printed circuit board; and a second conductive element movably mounted in the connection module such that the second conductive element is movable into an extended position, wherein the second conductive element is configured to engage the first mating contact area when the second conductive element is in the extended position and to engage a second like connection module at the second mating contact area of the first conductive element of the second like connection module when the second conductive element is in the extended position.

Optionally, such a connector may include one or more of the following features: the second conductive element is slidably mounted in the connection module to slide between a position in which the second conductive element is retracted into the connection module to enable the connection module to be inserted between a second like connection module and a third like connection module, and a position in which the second conductive element is extended into the second like connection module; the third mating contact area is positioned closer to the second mating contact area than the first mating contact area along the first axis; the first conductive element comprises a bar extending between the first end and the second end along the first axis, and electrically connecting the first mating contact area and the second mating contact area; the second conductive element is movably mounted in the connection module such that the second conductive element can engage with the second mating contact area of the first conductive element of the second like connection module when the first axis of the first portion of the second like connection module is offset from the first axis of the connection module by a distance up to at least 0.7 mm; the second conductive element is pivotably mounted in the connection module; the second conductive element is mounted to pivot about an axis perpendicular to the first axis; the second conductive element comprises a mating contact area, the second conductive element engages the second mating contact area of the first conductive element of the second like connection module at the mating contact area, and the second conductive element is configured to pivot so as to engage the second mating contact area at a location in a range of locations, wherein the range of locations is at least 1.5 mm; the second conductive element is movably mounted in the connection module to move along the first axis over a range of at least 10 mm; the connection module comprises a first housing and a second housing, slidably mounted with respect to the first housing, the first conductive element is mounted in the first housing, and the second conductive element is mounted in the second housing; the second conductive element comprises a mating contact area configured to engage the second mating contact area of the first conductive element of the second like connection module, the mating contact area of the second conductive element and the second mating contact area of the first conductive element of the second like connection module are configured to enable engagement between the second conductive element and the first conductive element of the second like connection module over a range of misalignment between the connection module and the second like connection module in a direction perpendicular to the first axis, and the range of misalignment is at least 0.8 mm; the mating contact area of the second conductive element is wider than the second mating contact area of the first conductive element of the second like connection module in the direction perpendicular to the first axis such that the mating contact area of the second conductive element engages the second mating contact area of the first conductive element of the second like connection module over the range of misalignment; each of the first mating contact area and the second mating contact area comprises a plurality of beams configured to engage the second conductive element, and the beams of the plurality of beams are arranged adjacent to one another along a second axis perpendicular to the first axis; the second conductive element has a mating contact area configured as a blade, and each of the first mating contact area and the second mating contact area comprises opposed compliant members shaped to receive the blade; a first housing having a mating face and holding the first conductive element, a second housing movably coupled to the first housing such that the second housing is movable between at least a first position with respect to the first housing and a second position with respect to the first housing, wherein the second conductive element is movably mounted in the second housing and positioned to be guarded by the first housing when the second housing is in the first position and to engage with the first mating contact area of the first conductive element and to engage the second like connection module at the second mating contact area of the first conductive element of the second like connection module when the second housing is in the second position; the second housing is movably coupled to the first housing such that the second housing slides relative to the first housing along the first axis; a screw rotatably engaged to the second housing and comprising threads, and a threaded opening in the first housing, wherein the screw is positioned to engage the threaded opening in the first housing when the second housing is in the second position; the second conductive element comprises a mating contact area, and the second conductive element is movably mounted to the second housing such that motion of the mating contact area along the first axis is constrained in at least one direction; the second housing is movably coupled to the first housing such that the second housing moves relative to the first housing along the first axis, when the second housing is in the first position, the second conductive element is within the first housing, when the second housing is in the second position, the second conductive element extends through the mating face of the first housing; when the second housing is in the second position, a mating contact area of the second conductive element extends through the mating face of the first housing; the first housing comprises a first member bounding a cavity comprising an opening and a cover over the opening, and the cover comprises the mating face; the cover comprises an opening, and the second conductive element extends through the opening when the second housing is in the second position; the second housing comprises a first insulative blade and a second insulative blade that extend through the mating face on opposite sides of the second conductive element when the second housing is in the second position; the second housing comprises an insulative surround for the second conductive element, the insulative surround comprising the first insulative blade and the second insulative blade; the connection module comprises a plurality of first conductive elements, including the first conductive element, held within the first housing, and the connection module comprises a plurality of second conductive elements, including the second conductive element, held within the second housing; the first conductive elements of the plurality of first conductive elements are arranged along a second axis perpendicular to the first axis, and the second conductive elements of the plurality of second conductive elements are arranged along the second axis; the second conductive element extends through the opening when the second housing is in the second position, and the first housing comprises a plurality of second members extending between the cover and the cavity along the first axis, and configured to engage one another and to guard the bar.

A third example of connector includes a connection module for an electronic assembly configured to engage with a like connection module and a printed circuit board, the connection module comprising: a first conductive element comprising: a first portion extending along a first axis from a first end to a second end, the first portion comprising a first mating contact area at the first end and a second mating contact area at the second end; and a second portion extending from the first portion transversely to the first axis and having an end opposite the first portion, the end of the second portion comprising a third mating contact area configured to engage a printed circuit board; a second conductive element comprising a first end configured to engage the first mating contact area and a second end comprising a mating contact area, wherein: the second conductive element is pivotally mounted in the connection module such that the mating contact area at the second end of the second conductive element moves in a direction perpendicular to the first axis when the second conductive element pivots.

Optionally, such a connector may include one or more of the following features: the second conductive element is slidably mounted in the connection module to slide between a position in which the second conductive element is retracted into the connection module to enable the connection module to be inserted between a second like connection module and a third like connection module, and a position in which the second conductive element is extended into the second like connection module; the third mating contact area is positioned closer to the second mating contact area than the first mating contact area along the first axis; the first conductive element comprises a bar extending between the first end and the second end along the first axis, and electrically connecting the first mating contact area and the second mating contact area; the second conductive element is movably mounted in the connection module such that the second conductive element can engage with the second mating contact area of the first conductive element of the second like connection module when the first axis of the first portion of the second like connection module is offset from the first axis of the connection module by a distance up to at least 0.7 mm; the second conductive element is mounted to pivot about an axis perpendicular to the first axis; the second conductive element comprises a mating contact area, the second conductive element engages the second mating contact area of the first conductive element of the second like connection module at the mating contact area, and the second conductive element is configured to pivot so as to engage the second mating contact area at a location in a range of locations, wherein the range of locations is at least 1.5 mm; the second conductive element is movably mounted in the connection module to move along the first axis over a range of at least 10 mm; the connection module comprises a first housing and a second housing, slidably mounted with respect to the first housing, the first conductive element is mounted in the first housing, and the second conductive element is mounted in the second housing; the second conductive element comprises a mating contact area configured to engage the second mating contact area of the first conductive element of the second like connection module, the mating contact area of the second conductive element and the second mating contact area of the first conductive element of the second like connection module are configured to enable engagement between the second conductive element and the first conductive element of the second like connection module over a range of misalignment between the connection module and the second like connection module in a direction perpendicular to the first axis, and the range of misalignment is at least 0.8 mm; the mating contact area of the second conductive element is wider than the second mating contact area of the first conductive element of the second like connection module in the direction perpendicular to the first axis such that the mating contact area of the second conductive element engages the second mating contact area of the first conductive element of the second like connection module over the range of misalignment; each of the first mating contact area and the second mating contact area comprises a plurality of beams configured to engage the second conductive element, and the beams of the plurality of beams are arranged adjacent to one another along a second axis perpendicular to the first axis; the second conductive element has a mating contact area configured as a blade, and each of the first mating contact area and the second mating contact area comprises opposed compliant members shaped to receive the blade; a first housing having a mating face and holding the first conductive element, a second housing movably coupled to the first housing such that the second housing is movable between at least a first position with respect to the first housing and a second position with respect to the first housing, wherein the second conductive element is pivotally mounted in the second housing and positioned to be guarded by the first housing when the second housing is in the first position and to engage with the first mating contact area of the first conductive element and to engage the second like connection module at the second mating contact area of the first conductive element of the second like connection module when the second housing is in the second position; the second housing is movably coupled to the first housing such that the second housing slides relative to the first housing along the first axis; the second housing is configured to be locked in the second position; the second conductive element is movably mounted to the second housing such that motion of the mating contact area along the first axis is constrained in at least one direction; the second housing is movably coupled to the first housing such that the second housing moves relative to the first housing along the first axis, when the second housing is in the first position, the second conductive element is within the first housing, and when the second housing is in the second position, the second conductive element extends through the mating face of the first housing; when the second housing is in the second position, the mating contact area of the second conductive element extends through the mating face of the first housing; the first housing comprises a first member bounding a cavity comprising an opening and a cover over the opening, and the cover comprises the mating face; the cover comprises an opening, and the second conductive element extends through the opening when the second housing is in the second position; the second housing comprises a first insulative blade and a second insulative blade that extend through the mating face on opposite sides of the second conductive element when the second housing is in the second position; the second housing comprises an insulative surround for the second conductive element, the insulative surround comprising the first insulative blade and the second insulative blade; the connection module comprises a plurality of first conductive elements, including the first conductive element, held within the first housing, and the connection module comprises a plurality of second conductive elements, including the second conductive element, held within the second housing; the first conductive elements of the plurality of first conductive elements are arranged adjacent to one another along a second axis perpendicular to the first axis, and the second conductive elements of the plurality of second conductive elements are arranged adjacent to one another along the second axis; the second conductive element extends through the opening when the second housing is in the second position, and the first housing comprises a plurality of second members extending between the cover and the cavity along the first axis, and configured to engage one another and to guard the connection bar.

A fourth example of an electronic assembly includes a plurality of connection modules configured for separable connection between the connection modules, wherein: a first connection module of the plurality of connection modules comprises a first mating interface comprising a first conductive element; a second connection module of the plurality of connection modules comprises a second mating interface comprising a second conductive element, wherein the second connection module is configured for connection to the first connection module at the first mating interface; the electronic assembly comprises a member comprising a third conductive element; and the member is movably mounted to move between a first position in which the third conductive element engages one of the first conductive element or the second conductive element and a second position in which the third conductive element engages both the first conductive element and the second conductive element.

Optionally, such a connector may include one or more of the following features: each of the plurality of connection modules is configured to engage with a printed circuit board; the member is configured to be locked in the second position; each of the first conductive element and the second conductive element comprises a first portion extending along a first axis from a first end of the respective connection module to a second end of the respective connection module, the first portion comprising a first mating contact area at the first end and a second mating contact area at the second end, and a second portion extending from the first portion transversely to the first axis and having an end opposite the first portion, the end of the second portion comprising a third mating contact area configured to engage a printed circuit board; the first mating contact area of the first conductive element is positioned at the first mating interface, and the second mating contact area of the second conductive element is positioned at the second mating interface; each of the first conductive element and the second conductive element comprises a first portion extending along a first axis from a first end of the respective connection module to a second end of the respective connection module, the first portion comprising a first mating contact area at the first end and a second mating contact area at the second end, and when the member is in the second position, the third conductive element can engage both the first conductive element and the second conductive element when the first axis of the first portion of the second conductive element is offset from the first axis of the first portion of the first conductive element by a distance up to at least 0.8 mm; each of the first conductive element and the second conductive element comprises a bar extending along the first axis between the first end and the second end of the respective connection module, and electrically connecting the first mating contact area and the second mating contact area of the first portion of the respective conductive element; wherein the third conductive element is pivotally mounted in the member; he third conductive element is mounted to pivot about an axis perpendicular to the first axis; the third conductive element comprises a mating contact area, when the member is in the second position, the third conductive element engages one of the first conductive element and the second conductive element at the mating contact area, and the third conductive element is configured to pivot so as to engage one of the first conductive element and the second conductive element at the mating contact area at a location in a range of locations, wherein the range of locations is at least 1.6 mm; the member is movably mounted to move along the first axis over a range of at least 10 mm; the third conductive element comprises a mating contact area configured to engage one of the first conductive element or the second conductive element when the member is in the second position, the mating contact area of the third conductive element and the one of the first conductive element or the second conductive element are configured to engage over a range of misalignment between the first connection module and the second connection module in a direction perpendicular to the first axis, and the range of misalignment is at least 0.7 mm; the mating contact area of the third conductive element is wider than both the first mating contact area and the second mating contact area in the direction perpendicular to the first axis such that the mating contact area of the third conductive element engages the one of the first conductive element or the second conductive element over the range of misalignment; each of the first mating contact area and the second mating contact area comprises a plurality of beams configured to engage a conductive element in the configuration of the third conductive element, and the beams of the plurality of beams are arranged adjacent to one another along a second axis perpendicular to the first axis; the third conductive element has a mating contact area configured as a blade, and each of the first mating contact area and the second mating contact area comprises opposed compliant members configured to receive a blade in the configuration of the third conductive element; the third conductive element is movably mounted in the member and positioned to be guarded within one of the first connection module or the second connection module when the member is in the first position; the member is movably coupled to the one of the first connection module or the second connection module such that the member slides relative to the one of the first connection module and the second connection module along the first axis; the third conductive element comprises a mating contact area, and the third conductive element is movably mounted in the member such that motion of the mating contact area along the first axis is constrained in at least one direction; the member is movably coupled to the one of the first connection module or the second connection module such that the member moves relative to the one of the first connection module or the second connection module along the first axis, when the member is in the first position, the third conductive element is within the one of the first connection module or the second connection module, and when the member is in the second position, the third conductive element extends through one of the first mating interface or the second mating interface; when the member is in the second position, a mating contact area of the third conductive element extends through the one of the first mating interface or the second mating interface; each of the first connection module and the second connection module comprises a first member bounding a cavity comprising an opening and a cover over the opening, the cover of the first connection module comprises the first mating interface, and the cover of the second connection module comprises the second mating interface; the cover of each of the first connection module and the second connection module comprises an opening, and the third conductive element extends through the opening of one of the cover of the first connection module or the cover of the second connection module when the member is in the second position; the member comprises a first insulative blade and a second insulative blade that extend through the one the first mating interface and the second mating interface on opposite sides of the third conductive element when the member is in the second position; the member comprises an insulative surround for the third conductive element, the insulative surround comprising the first insulative blade and the second insulative blade; the first mating interface of the first connection module comprises a plurality of first conductive elements, including the first conductive element, and the second mating interface of the second connection module comprises a plurality of second conductive elements, including the second conductive element; the member is movably coupled to one of the first connection module or the second connection module such that the member slides relative to the first connection module and the second connection module along the first axis; the first conductive elements of the plurality of first conductive elements are arranged along a second axis perpendicular to the first axis, and the second conductive elements of the plurality of second conductive elements are arranged along an axis parallel to the second axis; the third conductive element extends through the opening of one of the cover of the first connection module or the cover of the second connection module when the member is in the second position, and the housings of the respective connection modules are configured to guard the bar of the respective first conductive element and the second conductive element.

One or more of the techniques described herein may be used to support a method of operation. An example method of operating an electronic system including a plurality of connection modules includes, positioning a first connection module adjacent to a second connection module, wherein the first connection module is offset from the second connection module along a first axis; and moving a mating contact portion of a third conductive element from the first connection module into engagement with a second conductive element in the second connection module, wherein during the moving the mating contact portion is driven in the direction of the first axis and compliant in a direction perpendicular to the first axis.

Optionally, such a connector may include one or more of the following features: positioning the first connection module adjacent to a second connection module comprises inserting the first connection module in a gap between the second connection module and a third connection module; flowing current sequentially through one or more of the plurality of connection modules to each of a plurality of printed circuit boards coupled to respective connection modules of the plurality of connection modules, wherein the one or more of the plurality of connection modules comprises the first, second and third connection modules; the first connection module comprises a first conductive element and a member housing the third conductive element, wherein the member is movably mounted to move between a first position in which the third conductive element engages the first conductive element and a second position in which the third conductive element engages both the first conductive element and the second conductive element, and moving the mating contact portion of the third conductive element from the first connection module into engagement with the second conductive element in the second connection module comprises moving the member from the first position to the second position; locking the member in the second position; each of the first conductive element and the second conductive element comprises a first portion extending along the first axis from a first end of the respective connection module to a second end of the respective connection module, the first portion comprising a first mating contact area at the first end and a second mating contact area at the second end, and a second portion extending from the first portion transversely to the first axis and having an end opposite the first portion, the end of the second portion comprising a third mating contact area configured to engage a printed circuit board; when the member is in the first position, the third conductive element engages the first mating contact area of the first conductive element, and when the member is in the second position, the third conductive element engages both the first mating contact area of the first conductive element and the second mating contact area of the second conductive element; the third mating contact area is positioned closer to the second mating contact area than the first mating contact area along the first axis; each of the first conductive element and the second conductive element comprises a bar extending along the first axis between the first end and the second end of the respective connection module and electrically connecting the first mating contact area and the second mating contact area of the first portion of the respective conductive element; when the member is in the second position, the third conductive element can engage both the first mating contact area of the first conductive element and the second mating contact area of the second conductive element when the first axis of the first portion of the second conductive element is offset from the first axis of the first portion of the first conductive element by a distance up to at least 0.8 mm; the third conductive element is pivotally mounted in the housing member; the third conductive element is mounted to pivot about an axis perpendicular to the first axis; the third conductive element is configured to pivot so as to engage the second conductive element at the mating contact portion at a location in a range of locations, wherein the range of locations is at least 1.6 mm; the member is movably mounted to move along the first axis over a range of at least 10 mm; when the housing member is in the second position, the mating contact portion of the third conductive element and the second mating contact area of the second conductive element are configured to engage one another over a range of misalignment between the first connection module and the second connection module in a direction perpendicular to the first axis, and the range of misalignment is at least 0.8 mm; the mating contact portion of the third conductive element is wider than both the first mating contact area and the second mating contact area in the direction perpendicular to the first axis such that the mating contact area of the third conductive element engages the second mating contact area of the second conductive element over the range of misalignment; each of the first mating contact area and the second mating contact area comprises a plurality of beams configured to engage the third conductive element, and the beams of the plurality of beams are arranged adjacent to one another along a second axis perpendicular to the first axis; the mating portion of the third conductive element is configured as a blade, and each of the first mating contact area and the second mating contact area comprises opposed compliant members configured to receive a blade shaped as the third conductive element; the third conductive element is movably mounted in the housing member and positioned to be guarded within the first connection module when the housing member is in the first position; the housing member is movably coupled to the first connection module such that the housing member slides relative to the first connection module along the first axis, and moving the housing member from the first position to the second position comprises sliding the housing member along the first axis; the third conductive element is movably mounted in the housing member such that motion of the mating contact portion the first axis is constrained in at least one direction; the housing member is movably coupled to the first connection module such that the housing member moves relative to the first connection module along the first axis, when the member is in the first position, the third conductive element is within the first connection module, and moving the housing member from the first position to the second position comprises extending the third conductive element through a mating interface of the first connection module; moving the housing member from the first position to the second position comprises extending the mating contact portion of the third conductive element through the mating interface of the first connection module; each of the first connection module and the second connection module comprises a housing member bounding a cavity comprising an opening and a cover over the opening, and the cover of the first connection module comprises the mating interface of the first connection module; moving the housing member from the first position to the second position comprises extending the mating contact portion of the third conductive element through the opening of the first connection module; the housing member comprises a first insulative blade and a second insulative blade that extend through the mating interface of the first connection module on opposite sides of the third conductive element when the housing member is in the second position; the housing member comprises an insulative surround for the third conductive element, the insulative surround comprising the first insulative blade and the second insulative blade; the first connection module comprises a plurality of like first conductive elements, including the first conductive element, and the second connection module comprises a plurality of like second conductive elements, including the second conductive element; the housing member is movably coupled to the first connection module such that the housing member slides relative to the first connection module along the first axis; the first conductive elements of the plurality of first conductive elements are arranged adjacent to one another along a second axis perpendicular to the first axis, and the second conductive elements of the plurality of second conductive elements are arranged adjacent to one another along the second axis; moving the second housing member from the first position to the second position comprises extending the third conductive element through the opening of the cover of the first connection module, and each of the first connection module and the second connection module comprises a plurality of second members extending between the cover and the cavity of the respective connection module along the first axis and configured to engage one another and to guard the bar of the respective conductive element.

Having thus described several aspects of at least one embodiment of this invention, it is to be appreciated that various alterations, modifications, and improvements will readily occur to those skilled in the art. For example, though connectors that compensate for misalignment were illustrated in connection with a bus bar module, the connectors and connector construction techniques described herein may be used for other purposes or in other types of connectors.

As one example, power is described as flowing to PCBs connected to bus bar modules. Power flow is described in specific directions for simplicity as the bus bar modules described herein may be used for power flow in any direction. A PCB connected to a bus bar module, for example, may be a power supply sourcing power to other PCBs connected to other bus bar modules.

As another example, a header module was described that could be connected to a power source. Any or multiple bus bar modules in a power distribution subsystem may be connected to a power source.

As yet another example, impact on mating of adjacent modules due to misalignment may be judged in any suitable way. For example, an impact may be assessed based on change in mating interface properties, such as heating or contact resistance. A change relative to a state in which adjacent modules are aligned in heat generated at the mating interface and/or contact resistance may indicate an impact. In some examples, a change above a threshold may be considered an impact. That threshold, for example, may be 1%, 3%, 5% or 10% in some examples.

As yet a further example, connectors were described as integrated into bus bar modules to accommodate for misalignment of the bus bar modules. Connectors as described herein may be integrated into other structures.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though described/shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

Numerical values and ranges may be described in the specification and claims as approximate or exact values or ranges. For example, in some cases the terms “about,” “approximately,” and “substantially” may be used in reference to a value. Such references are intended to encompass the referenced value as well as plus and minus reasonable variations of the value. For example, a phrase “between 10 and 20” is intended to mean “between exactly 10 and exactly 20” in some embodiments, as well as “between 10±d1 and 20±d2” in some embodiments. The amount of variation d1, d2 for a value may be less than 5% of the value in some embodiments, less than 10% of the value in some embodiments, and yet less than 20% of the value in some embodiments. When only exact values are intended, the term “exactly” is used, e.g., “between exactly 2 and exactly 200.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A connection module for an electronic assembly configured to engage with a like connection module and a printed circuit board, the connection module comprising:
a first conductive element comprising:
a first portion extending along a first axis from a first end to a second end, the first portion comprising a first mating contact area at the first end and a second mating contact area at the second end; and
a second portion extending from the first portion transversely to the first axis and having an end opposite the first portion, the end of the second portion comprising a third mating contact area configured to engage a printed circuit board; and
a second conductive element movably mounted in the connection module such that the second conductive element is movable into an extended position, wherein the second conductive element is configured to engage the first mating contact area when the second conductive element is in the extended position and to engage a second like connection module at the second mating contact area of the first conductive element of the second like connection module when the second conductive element is in the extended position.

2. The connection module of claim 1, wherein the second conductive element is slidably mounted in the connection module to slide between:
a position in which the second conductive element is retracted into the connection module to enable the connection module to be inserted between a second like connection module and a third like connection module; and
a position in which the second conductive element is extended into the second like connection module.

3. The connection module of claim 1, wherein the second conductive element is movably mounted in the connection module such that the second conductive element can engage with the second mating contact area of the first conductive element of the second like connection module when the first axis of the first portion of the second like connection module is offset from the first axis of the connection module by a distance up to at least 0.7 mm.

4. The connection module of claim 3, wherein:
the second conductive element comprises a mating contact area;
the second conductive element engages the second mating contact area of the first conductive element of the second like connection module at the mating contact area; and
the second conductive element is configured to pivot so as to engage the second mating contact area at a location in a range of locations, wherein the range of locations is at least 1.5 mm.

5. The connection module of claim 3, wherein:
each of the first mating contact area and the second mating contact area comprises a plurality of beams configured to engage the second conductive element; and
the beams of the plurality of beams are arranged adjacent to one another along a second axis perpendicular to the first axis.

6. The connection module of claim 3, wherein:
the second conductive element has a mating contact area configured as a blade; and
each of the first mating contact area and the second mating contact area comprises opposed compliant members shaped to receive the blade.

7. The connection module of claim 3, further comprising:
a first housing having a mating face and holding the first conductive element;
a second housing movably coupled to the first housing such that the second housing is movable between at least a first position with respect to the first housing and a second position with respect to the first housing, wherein:
the second conductive element is movably mounted in the second housing and positioned to be guarded by the first housing when the second housing is in the first position and to engage with the first mating contact area of the first conductive element and to engage the second like connection module at the second mating contact area of the first conductive element of the second like connection module when the second housing is in the second position.

8. A connection module for an electronic assembly configured to engage with a like connection module and a printed circuit board, the connection module comprising:
a first conductive element comprising:
a first portion extending along a first axis from a first end to a second end, the first portion comprising a first mating contact area at the first end and a second mating contact area at the second end; and
a second portion extending from the first portion transversely to the first axis and having an end opposite the first portion, the end of the second portion comprising a third mating contact area configured to engage a printed circuit board;
a second conductive element comprising a first end configured to engage the first mating contact area and a second end comprising a mating contact area,
wherein:
the second conductive element is pivotally mounted in the connection module such that the mating contact area at the second end of the second conductive element moves in a direction perpendicular to the first axis when the second conductive element pivots.

9. The connection module of claim 8, wherein the second conductive element is slidably mounted in the connection module to slide between:
a position in which the second conductive element is retracted into the connection module to enable the connection module to be inserted between a second like connection module and a third like connection module; and
a position in which the second conductive element is extended into the second like connection module.

10. The connection module of claim 8, wherein:
the first conductive element comprises a bar extending along the first axis between the first end and the second end, and electrically connecting the first mating contact area to the second mating contact area.

11. The connection module of claim 8, wherein the second conductive element is pivotally mounted in the connection module such that the mating contact area of the second conductive element can engage with the second mating contact area of the first conductive element of a second like connection module when the first axis of the first portion of the second like connection module is offset from the first axis of the connection module by a distance up to at least 0.7 mm.

12. The connection module of claim 11, wherein:
the mating contact area of the second conductive element and the second mating contact area of the first conductive element of the second like connection module are configured to enable engagement between the second conductive element and the first conductive element of the second like connection module over a range of misalignment between the connection module and the second like connection module in a direction perpendicular to the first axis; and
the range of misalignment is at least 0.8 mm.

13. The connection module of claim 12, wherein:
the mating contact area of the second conductive element is wider than the second mating contact area of the first conductive element of the second like connection module in the direction perpendicular to the first axis such that the mating contact area of the second conductive element engages the second mating contact area of the first conductive element of the second like connection module over the range of misalignment.

14. The connection module of claim 11, further comprising:
a first housing having a mating face and holding the first conductive element;
a second housing movably coupled to the first housing such that the second housing is movable between at least a first position with respect to the first housing and a second position with respect to the first housing, wherein:
the second conductive element is pivotally mounted in the second housing and positioned to be guarded by the first housing when the second housing is in the first position and to engage with the first mating contact area of the first conductive element and to engage the second like connection module at the second mating contact area of the first conductive element of the second like connection module when the second housing is in the second position.

15. An electronic assembly comprising a plurality of connection modules configured for separable connection between the connection modules, wherein:
a first connection module of the plurality of connection modules comprises a first mating interface comprising a first conductive element;
a second connection module of the plurality of connection modules comprises a second mating interface comprising a second conductive element, wherein the second connection module is configured for connection to the first connection module at the first mating interface;
the electronic assembly comprises a member comprising a third conductive element; and
the member is movably mounted to move between a first position in which the third conductive element engages one of the first conductive element or the second conductive element and a second position in which the third conductive element engages both the first conductive element and the second conductive element.

16. The electronic assembly of claim 15, wherein:
each of the plurality of connection modules is configured to engage with a printed circuit board.

17. The electronic assembly of claim 15, wherein:
the member is configured to be locked in the second position.

18. The electronic assembly of claim 15, wherein:
each of the first conductive element and the second conductive element comprises:
a first portion extending along a first axis from a first end of the respective connection module to a second end of the respective connection module, the first portion comprising a first mating contact area at the first end and a second mating contact area at the second end; and
a second portion extending from the first portion transversely to the first axis and having an end opposite the first portion, the end of the second portion comprising a third mating contact area configured to engage a printed circuit board.

19. The electronic assembly of claim 18, wherein:
the first mating contact area of the first conductive element is positioned at the first mating interface; and
the second mating contact area of the second conductive element is positioned at the second mating interface.

20. The electronic assembly of claim 15, wherein:
each of the first conductive element and the second conductive element comprises:
a first portion extending along a first axis from a first end of the respective connection module to a second end of the respective connection module, the first portion comprising a first mating contact area at the first end and a second mating contact area at the second end; and
when the member is in the second position, the third conductive element can engage both the first conductive element and the second conductive element when the first axis of the first portion of the second conductive element is offset from the first axis of the first portion of the first conductive element by a distance up to at least 0.8 mm.
